(19) United States
(12) Patent Application Publication
(10) Pub. No.: US 2026/0368247 A1
(43) Pub. Date: Nov. 19, 2026

(54) METHOD FOR CONSTRUCTING AN INFERENCE PIPELINE FOR MULTI-MODAL ANALYSIS, AND AN APPARATUS AND A SYSTEM FOR PERFORMING THE SAME

(71) Applicant: NOTA, INC., Daejeon (KR)

(72) Inventors: Kwan geun Ko, Daejeon (KR); Won dong Kim, Daejeon (KR); Tae seong Moon, Daejeon (KR)

(21) Appl. No.: 19/679,533

(22) Filed: May 15, 2026

(30) Foreign Application Priority Data
May 16, 2025 (KR) 10-2025-0064094
Nov. 28, 2025 (KR) 10-2025-0184642

(51) Int. Cl. G06F 16/535

(52) U.S. Cl. CPC G06F 16/535

(57) ABSTRACT

A method for constructing an inference pipeline for multi-modal analysis by industry domain according to an embodiment of the present application comprises obtaining an image processing pipeline package and an inference engine for multi-modal analysis; obtaining, through a client terminal, a setting command for a target rule set related to a specific industry domain among a plurality of rule sets compatible with the inference engine, wherein each of the rule sets defines an inference requirement for a structured vision task for an unstructured vision task inference using a general-purpose inference model with respect to an industry domain; obtaining, from the image processing pipeline package, at least one image processing pipeline that satisfies the inference requirement of the target rule set, based on the setting command for the target rule set; and constructing the inference pipeline based on the at least one image processing pipeline and the inference engine.

### CROSS-REFERENCE TO RELATED APPLICATIONS

This application claims priority to and the benefit of Korean Patent Application No. 10-2025-0064094, filed on May 16, 2025, in the Korean Intellectual Property Office and Korean Patent Application No. 10-2025-0184642, filed on Nov. 28, 2025, in the Korean Intellectual Property Office, the entire disclosure of which is incorporated herein by reference.

### TECHNICAL FIELD

The present application relates to the field of artificial intelligence analysis technology, and more particularly, to a real-time situation recognition system using image signal processing, computer vision systems, multi-sensor analysis, and multi-modal inference. Specifically, the present invention relates to an integrated management platform that deploys AI software applicable to various industry domains in computing environments and automates and simplifies the configuration and operation thereof. In addition, the present invention relates to a real-time image processing and analysis system that extracts metadata and processed industry data from input images and detects hazardous situations based thereon.

### BACKGROUND

With the recent advancement of artificial intelligence (AI) technology, the introduction of AI-based analysis applications has been increasing in fields such as transportation, industrial safety, public surveillance, and security. To secure the detection performance and processing speed of AI systems, settings optimized for the analysis target and on-site environment are essential. Accordingly, the need for edge computing technology, which directly processes and analyzes information at on-site servers where data is generated, has been increasing.

A real-time multi-source image analysis system needs to support various input methods such as RTSP and image files, and should operate in various hardware environments ranging from high-performance servers to low-spec edge devices. In particular, in low-spec hardware, an optimization design is necessary to ensure efficient performance with limited computational resources.

However, conventional AI system deployment and operation technologies have had the following limitations.

First, fragmentation and complexity of the deployment procedure existed. To operate an AI system, processes such as adding a server, uploading software packages and AI models, registering data input sources, and creating service stack components had to be performed sequentially. Such tasks were performed in a fragmented manner through individual tools or command-line interfaces (CLI), making it difficult to intuitively grasp the entire deployment process and resulting in excessive task time.

Second, a high level of technical expertise was required. Each deployment step required specialized knowledge of server management, container technology, network configuration, and AI model management. As a result, only experienced developers or system engineers could perform the tasks, and it was difficult for on-site engineers or customers to configure the system directly. This caused increased dependence on human resources and increased maintenance costs.

Third, hardware-specific pipelines were dispersed. Conventional technologies used hardware-specific SDKs (e.g., NVIDIA DeepStream, Qualcomm IM SDK) or general-purpose image processing technologies (e.g., gstreamer) in order to optimize the computational performance of each piece of hardware. In this process, pipelines were dispersed for each piece of hardware, making design and maintenance difficult, and the scalability and interoperability in distributed edge or server systems were limited.

Fourth, there was excessive reliance on predefined rules. Conventional technologies detected specific situations according to predefined rules. Specifically, according to the conventional technology, AI models had to be trained in advance for the detection target, or rules such as parameter adjustment and region-of-interest setting had to be defined. In addition, when combining the inference results of multiple AI models, or when combining sensors and AI models, the combination methods had to be defined in advance. Accordingly, responsiveness to open-ended situations not predefined was insufficient.

Fifth, the linkage between the rule sets and the hardware environment was not clear. Conventional technologies lacked a mechanism for effectively connecting analysis requirements for a specific industry domain with pipelines optimized for each piece of hardware. As a result, when deploying the same rules to different hardware environments, the pipelines had to be reconfigured, and the reusability and portability of rule sets were limited.

Sixth, analyses that did not consider the context of situations were performed. Conventional technologies failed to consider the context of unusual situations occurring in images, and frequently detected multiple duplicated unusual situations for one actual situation. This degraded the accuracy of the system and generated unnecessary alerts.

Seventh, the progress stages of an event could not be distinguished. Conventional technologies merely detected the occurrence of an event, or processed events with a single rule without distinguishing among the progress stages of an event (occurrence, action, end), thereby failing to accurately reflect the actual changes in the event situation. In addition, mechanisms for preventing misjudgments due to temporary changes in the situation were lacking.

Therefore, there is a need for the development of and research into a new technology that integrates the fragmented AI system deployment process, can be efficiently operated in various hardware environments, systematically links hardware and analysis requirements based on rule sets, can recognize even situations not predefined, can understand the context of situations to provide integrated information, and can systematically track the progress stages of an event.

### SUMMARY

The present invention is intended to solve the problems of the conventional technologies described above, and aims to solve the following problems.

One problem to be solved by the present invention is to provide a GUI-based integrated management platform that integrates the complex and fragmented AI system deployment process into a single intuitive workflow and abstracts the technical complexity, so that even non-experts can deploy systems quickly and accurately.

One problem to be solved by the present invention is to provide an image processing pipeline package that can be operated in an integrated manner on various hardware ranging from high-performance servers to low-spec edge devices, thereby solving the problem of dispersed pipelines for each piece of hardware and facilitating design and maintenance.

One problem to be solved by the present invention is to define an inference requirement for an image processing pipeline through a rule set for each industry domain, and to automatically map the image processing pipeline and a general-purpose inference model based on a rule set identifier, thereby systematically linking the hardware environment with the analysis requirements and improving the reusability and portability of the rule set.

One problem to be solved by the present invention is to provide an inference engine that processes metadata and industry data extracted from an image processing pipeline through a vision-language model (VLM) to understand the context of the data and recognize non-rule-based situations, thereby being able to detect even open-ended situations not predefined.

One problem to be solved by the present invention is to store detection results based on predefined rules and detection results of non-rule-based situations in a short-term memory (STM) to preserve and utilize the context between events, thereby providing several situations that have a dependent relationship but are independently understood as one integrated situation, thereby improving context understanding performance.

One problem to be solved by the present invention is to provide an event management system capable of adaptively applying different rules and queries according to the progress stage of the event (occurrence, action, end) to perform an analysis optimized for each stage, and capable of systematically tracking the entire life cycle of the event.

One problem to be solved by the present invention is to provide a method capable of preventing misjudgments due to temporary changes in the situation when determining the end of the event, by setting a delay period to verify whether the event recurs, and capable of utilizing the context of past events stored in the short-term memory, thereby increasing the reliability and accuracy of the event analysis.

The problems to be solved by the present invention are not limited to the problems described above, and unmentioned problems may be clearly understood by those of ordinary skill in the art to which the present invention pertains from the present specification and the accompanying drawings.

A method for constructing an inference pipeline for multi-modal analysis by industry domain according to an embodiment of the present application may further comprise: obtaining an image processing pipeline package and an inference engine for multi-modal analysis, wherein the inference engine includes a domain agnostic general-purpose inference model and an industry domain-adaptive data processing logic; obtaining, through a client terminal, a setting command for a target rule set related to a specific industry domain among a plurality of rule sets compatible with the inference engine, wherein each of the rule sets defines an inference requirement for a structured vision task for an unstructured vision task inference using the general-purpose inference model with respect to an industry domain; obtaining, from the image processing pipeline package, at least one image processing pipeline that satisfies the inference requirement of the target rule set, based on the setting command for the target rule set; and constructing the inference pipeline based on the at least one image processing pipeline and the inference engine.

The solutions to the problems of the present invention are not limited to the solutions described above, and unmentioned solutions may be clearly understood by those of ordinary skill in the art to which the present invention pertains from the present specification and the accompanying drawings.

According to a method for constructing an inference pipeline, a method for analyzing an event using the inference pipeline, a method for providing event information, an apparatus, and/or a system for performing the same according to an embodiment of the present application, by systematically managing the entire process of deploying an AI analysis application through a GUI-based integrated platform, the complex and fragmented deployment process can be integrated into a single intuitive workflow. Through this, even non-experts can deploy systems quickly and accurately, thereby providing the effects of shortening the deployment time, reducing dependence on human resources, and reducing maintenance costs.

According to a method for constructing an inference pipeline, a method for analyzing an event using the inference pipeline, a method for providing event information, an apparatus, and/or a system for performing the same according to an embodiment of the present application, by providing an image processing pipeline package that can be operated in an integrated manner on various pieces of hardware, the problem of pipeline design and maintenance dispersed for each piece of hardware can be solved, and the scalability and interoperability in distributed edge or server systems can be improved.

According to a method for constructing an inference pipeline, a method for analyzing an event using the inference pipeline, a method for providing event information, an apparatus, and/or a system for performing the same according to an embodiment of the present application, by defining the inference requirement for a structured vision task through a rule set, and automatically mapping the image processing pipeline and the general-purpose inference model based on the rule set identifier, the same rule set can be easily deployed to different hardware environments. Through this, the reusability and portability of rule sets are improved, and the system can be quickly constructed without redefining the rule set even when the hardware is changed.

According to a method for constructing an inference pipeline, a method for analyzing an event using the inference pipeline, a method for providing event information, an apparatus, and/or a system for performing the same according to an embodiment of the present application, by providing an architecture that is stably linked in a distributed environment, an efficient system configuration in which the image processing pipeline operates on low-spec hardware and the inference engine operates on high-spec hardware is possible. Through this, the effects of optimally utilizing hardware resources and securing scalability of the system can be achieved.

According to a method for constructing an inference pipeline, a method for analyzing an event using the inference pipeline, a method for providing event information, an apparatus, and/or a system for performing the same according to an embodiment of the present application, by selecting and deploying software packages and AI models optimized for the hardware specifications of the server on which the analysis is to be performed, the effects of securing maximum performance in each hardware environment and increasing the stability and efficiency of the system can be achieved.

According to a method for constructing an inference pipeline, a method for analyzing an event using the inference pipeline, a method for providing event information, an apparatus, and/or a system for performing the same according to an embodiment of the present application, by allowing the user to intuitively configure rule sets and parameters through a GUI, the effects of simplifying the operation of complex AI systems and enabling on-site engineers or non-experts to easily manage the system can be achieved.

According to a method for constructing an inference pipeline, a method for analyzing an event using the inference pipeline, a method for providing event information, an apparatus, and/or a system for performing the same according to an embodiment of the present application, by providing an inference engine utilizing a vision-language model (VLM), it is possible to understand the context of data and recognize unstructured situations, thereby being able to detect even open-ended situations not predefined. Through this, the problem of excessive reliance on predefined rules can be solved, and the effect of enabling more flexible and intelligent situation recognition can be achieved.

According to a method for constructing an inference pipeline, a method for analyzing an event using the inference pipeline, a method for providing event information, an apparatus, and/or a system for performing the same according to an embodiment of the present application, by utilizing a short-term memory to preserve and utilize the context between events, several situations that have a dependent relationship but are independently understood can be provided as a single integrated situation. Through this, duplicated alerts are reduced and the accuracy of situation recognition is improved, thereby providing the effect of improving the user experience.

According to a method for constructing an inference pipeline, a method for analyzing an event using the inference pipeline, a method for providing event information, an apparatus, and/or a system for performing the same according to an embodiment of the present application, by adaptively switching the analysis rule according to the progress stage of the event and generating queries optimized for each stage, the event can be systematically tracked from occurrence to end, and clear status information for each stage can be provided to the user. Through this, the effects of preventing unnecessary duplicate detection and enabling prompt and appropriate response can be achieved.

According to a method for constructing an inference pipeline, a method for analyzing an event using the inference pipeline, a method for providing event information, an apparatus, and/or a system for performing the same according to an embodiment of the present application, by monitoring whether the event recurs during a predetermined delay period after determining the end of the event, and by utilizing the short-term memory to perform analysis taking into account the context of past events, temporary misjudgments can be prevented, and the reliability of the event analysis can be improved. In addition, by understanding several events having dependent relationships as one integrated situation, duplicated alerts can be prevented, and the user experience can be improved.

The effects of the present invention are not limited to the effects described above, and unmentioned effects may be clearly understood by those of ordinary skill in the art to which the present invention pertains from the present specification and the accompanying drawings.

### BRIEF DESCRIPTION OF THE DRAWINGS

FIG. 1 is a schematic diagram illustrating an event analysis system according to an embodiment of the present application.

FIG. 2 is a diagram illustrating a detailed configuration of an analysis server and a structure of an inference pipeline according to an embodiment of the present invention.

FIG. 3 is a diagram for explaining an aspect of event analysis performed by the event analysis system according to an embodiment of the present application.

FIG. 4 is a flowchart illustrating a method for constructing an inference pipeline (analysis pipeline) according to an embodiment of the present application.

FIGS. 5A-5B are diagrams illustrating an exemplary graphical user interface of a client terminal for explaining an aspect of receiving a setting command for a target rule set from the client terminal according to an embodiment of the present application.

FIG. 6 is a diagram illustrating an exemplary graphical user interface of a client terminal for explaining an aspect of receiving a setting command for a target rule set from the client terminal according to an embodiment of the present application.

FIG. 7 is a specific flowchart of a step (S1400) of constructing the inference pipeline according to an embodiment of the present application.

FIG. 8 is a diagram illustrating an exemplary graphical user interface of a client terminal for explaining an aspect of receiving a setting command for allocating a resource for an image processing pipeline from the client terminal according to an embodiment of the present application.

FIGS. 9A-9B are diagrams illustrating an exemplary graphical user interface of a client terminal for explaining an aspect of receiving a setting command for selecting a channel to be linked with an artificial intelligence model that is to be executed on an image processing pipeline from the client terminal according to an embodiment of the present application.

FIG. 10 is a diagram for explaining an aspect of constructing an inference pipeline according to an embodiment of the present application.

FIG. 11 is a diagram for explaining an aspect of constructing an inference pipeline and an aspect of performing inference using the inference pipeline according to an embodiment of the present application.

FIG. 12 is a diagram for explaining an aspect of analyzing an event using the constructed inference pipeline according to an embodiment of the present application.

FIG. 13 is a flowchart illustrating a method for constructing an inference pipeline according to another embodiment of the present application.

FIG. 14 is a flowchart illustrating a method for analyzing an event using the constructed inference pipeline according to an embodiment of the present application.

FIG. 15 is a diagram for explaining an aspect of detecting an exemplary event using the constructed inference pipeline according to an embodiment of the present application.

FIG. 16 is a diagram for explaining an aspect of detecting an exemplary event using the constructed inference pipeline according to an embodiment of the present application.

FIG. 17 is a diagram for explaining an aspect of detecting an exemplary event using the constructed inference pipeline according to an embodiment of the present application.

FIG. 18 is a diagram for explaining an aspect of detecting an exemplary event using the constructed inference pipeline according to an embodiment of the present application.

FIG. 19 is a flowchart illustrating a method for providing information about an event according to an embodiment of the present application.

FIG. 20 is a specific flowchart of a method for providing information about an event according to an embodiment of the present application.

FIGS. 21A-21B are diagrams for explaining an aspect of event analysis according to a progress stage of an event according to an embodiment of the present application.

FIGS. 22A-22B are diagrams for explaining an aspect of event analysis according to a progress stage of an event according to an embodiment of the present application.

FIG. 23 is a diagram for explaining an aspect of event analysis according to a progress stage of an event according to an embodiment of the present application.

FIGS. 24A-24C are diagrams for explaining an aspect of event analysis according to a progress stage of an event according to an embodiment of the present application.

FIGS. 25A-25B are diagrams for explaining an aspect of event information provided according to a progress stage of an event according to an embodiment of the present application.

### DETAILED DESCRIPTION

The above-described objects, features, and advantages of the present application will become more apparent through the following detailed description with reference to the accompanying drawings. However, since the present application can be subject to various modifications and can have various embodiments, specific embodiments will be illustrated in the drawings and described in detail hereinafter.

Throughout the specification, identical reference numerals fundamentally denote identical components. In addition, components having the same function within the scope of the same idea shown in the drawings of each embodiment will be described using the same reference numerals, and redundant descriptions thereof will be omitted.

When it is determined that a detailed description of a known function or configuration related to the present application may unnecessarily obscure the gist of the present application, the detailed description thereof will be omitted. In addition, numbers (e.g., first, second, etc.) used in the description of the present specification are merely identification symbols for distinguishing one component from another.

In addition, the suffixes “module” and “part” for components used in the following embodiments are given or used interchangeably solely in consideration of the ease of writing the specification, and do not in themselves have meanings or roles distinguished from each other.

In the following embodiments, the singular expression includes the plural expression unless the context clearly dictates otherwise.

In the following embodiments, terms such as “include” or “have” mean that features or components described in the specification exist, and do not preclude the possibility that one or more other features or components may be added.

In the drawings, the sizes of components may be exaggerated or reduced for the convenience of explanation. For example, the size and thickness of each component shown in the drawings are arbitrarily shown for the convenience of explanation, and the present invention is not necessarily limited to what is shown.

When an embodiment is implementable differently, the order of a particular process may be performed differently from the described order. For example, two processes that are described in succession may be performed substantially simultaneously, or may proceed in the reverse order to the described order.

In the following embodiments, when it is said that components are connected, this includes not only the case where the components are directly connected but also the case where components are interposed between the components and connected indirectly. For example, in the present specification, when it is said that components are electrically connected, this includes not only the case where the components are directly electrically connected but also the case where components are interposed between them and are indirectly electrically connected.

A method, performed by an electronic device, for constructing an inference pipeline for multi-modal analysis by industry domain according to an embodiment of the present application may further comprise: obtaining an image processing pipeline package and an inference engine for multi-modal analysis, wherein the inference engine includes a domain agnostic general-purpose inference model and an industry domain-adaptive data processing logic; obtaining, through a client terminal, a setting command for a target rule set related to a specific industry domain among a plurality of rule sets compatible with the inference engine, wherein each of the rule sets defines an inference requirement for a structured vision task for an unstructured vision task inference using the general-purpose inference model with respect to an industry domain; obtaining, from the image processing pipeline package, at least one image processing pipeline that satisfies the inference requirement of the target rule set, based on the setting command for the target rule set; and constructing the inference pipeline based on the at least one image processing pipeline and the inference engine.

According to an embodiment of the present application, one or more rule sets are generated for each industry domain; the inference requirement of each rule set includes a type of structured vision inference tasks corresponding to one of a plurality of unstructured vision inference tasks predefined within one industry domain; and the type of the structured vision inference tasks may include at least one of object detection, segmentation, classification, object tracking, and pose estimation.

According to an embodiment of the present application, each of the rule sets may include a rule item and a user-modifiable parameter for generating input data of the general-purpose inference model from an output of an image processing pipeline included in the image processing pipeline package for each industry domain.

According to an embodiment of the present application, obtaining the setting command for the target rule set may further comprise: providing, through the client terminal, the compatible rule sets; receiving, through the client terminal, a first input for selecting the target rule set from among the compatible rule sets; receiving, through the client terminal, a second input for selecting a specific channel to which the target rule set is to be applied; and receiving, through the client terminal, a third input for a setting value of the user-modifiable parameter.

According to an embodiment of the present application, obtaining the setting command for the target rule set may further comprise: obtaining, based on the first input through the third input, a target rule, generated by applying the setting value for the user-modifiable parameter to the rule item belonging to the target rule set, for generating the input data of the inference engine, with respect to the specific channel.

According to an embodiment of the present application, the user-modifiable parameter includes a site-adaptive parameter, and the site-adaptive parameter may include a first parameter related to at least one of crop, padding, confidence threshold, region of interest, frame drop rate, frame interval, and an object type to be detected for analysis through the image processing pipeline, and a second parameter related to a query to be input to the general-purpose inference model.

According to an embodiment of the present application, the target rule may include at least one of: a rule set identifier corresponding to the target rule set; a rule identifier corresponding to the target rule; first information regarding a parameter for configuring an output form of the image processing pipeline or a task of the image processing pipeline; second information regarding a query template associated with the rule identifier; third information for generating, as the input data to be input to the general-purpose inference model, a query based on the query template and the output of the image processing pipeline; and fourth information regarding a logic associated with the rule identifier and for processing an output of the general-purpose inference model.

According to an embodiment of the present application, obtaining the setting command for the target rule set may further comprise: obtaining first rule set information and first rule information previously assigned to the specific channel; receiving a setting command for a candidate rule set and a candidate rule, based on the first input through the third input; and restricting the candidate rule from being received as the target rule suitable for analysis with respect to the specific channel when the candidate rule set is identical to the rule set indicated by the first rule set information, and receiving the candidate rule as the target rule suitable for analysis with respect to the specific channel when the candidate rule set is different from the rule set indicated by the first rule set information.

According to an embodiment of the present application, obtaining the setting command for the target rule set may further comprise: obtaining second rule set information and second rule information previously assigned to a channel different from the specific channel; receiving a setting command for a candidate rule set and a candidate rule, based on the first input through the third input; and receiving the candidate rule, which is different from the second rule information, as the target rule suitable for analysis with respect to the specific channel, even when the candidate rule set is identical to the rule set indicated by the second rule set information.

According to an embodiment of the present application, constructing the inference pipeline may further comprise: constructing the inference pipeline by configuring the image processing pipeline to perform an analysis corresponding to an inference requirement corresponding to the target rule for a structured vision task for vision task inference using the general-purpose inference model, by applying the target rule with respect to the specific channel, based on the at least one image processing pipeline and the target rule.

According to an embodiment of the present application, constructing the inference pipeline may further comprise: generating, in response to the setting value for the user-modifiable parameter being input through the third input, structured data defining the input data of the inference engine; and constructing the inference pipeline by configuring the image processing pipeline to generate the input data of the inference engine for the specific channel using the structured data.

According to an embodiment of the present application, the method for constructing the inference pipeline may further comprise: storing rule management information including at least one of an identifier of the image processing pipeline included in the inference pipeline, a parameter for executing the image processing pipeline, an identifier of a region of interest configured to be detected through the image processing pipeline, a rule set identifier corresponding to the target rule set applied for each region of interest, and a rule identifier corresponding to the target rule belonging to the target rule set, through the industry domain-adaptive data processing logic, wherein the rule management information is stored on a per-channel basis.

According to an embodiment of the present application, the industry domain-adaptive data processing logic of the inference pipeline may be configured to: identify the rule set identifier included in the output of the image processing pipeline with reference to the rule set identifier of the rule management information; map the general-purpose inference model of the inference pipeline that is to perform the unstructured vision task inference based on the identified rule set identifier; and input the input data generated by applying the target rule into the mapped general-purpose inference model.

According to an embodiment of the present application, the industry domain-adaptive data processing logic of the inference pipeline may be configured to: obtain the query template associated with the rule identifier with reference to the rule identifier of the rule management information; and generate the input data by computing a variable included in the query template using the output of the image processing pipeline.

According to an embodiment of the present application, constructing the inference pipeline may further comprise: allocating a resource for the image processing pipeline; configuring an artificial intelligence model to be executed on the image processing pipeline; configuring a channel for receiving an image to be analyzed on the inference pipeline; and constructing the inference pipeline by generating a container of the inference pipeline based on the allocated resource, the configured artificial intelligence model, and the configured channel.

According to an embodiment of the present application, the artificial intelligence model is selected, from a model pool including a plurality of models optimized for different hardware, as at least one artificial intelligence model whose performance has been verified for hardware specification information of a server on which analysis is to be performed; and the image processing pipeline package is selected, from a pipeline pool including a plurality of image processing pipelines optimized for different hardware, as at least one image processing pipeline whose performance has been verified for the hardware specification information of the server on which the analysis is to be performed.

According to an embodiment of the present application, the general-purpose inference model of the inference engine may be selected, from a model pool including a plurality of inference models optimized for different hardware, as at least one general-purpose inference model whose performance has been verified in consideration of compatibility with the image processing pipeline and hardware specification information of a server on which analysis is to be performed.

According to an embodiment of the present application, obtaining the setting command for the target rule set may further comprise receiving a rule setting command for at least one of a first target rule set and a second target rule set, wherein when the setting command for the first target rule set is received, the inference pipeline is constructed such that a first pipeline group composed of at least one of a first image processing pipeline and a second image processing pipeline is constructed as the at least one image processing pipeline; and when the setting command for the second target rule set is received, the inference pipeline is constructed such that a second pipeline group composed of at least one of the second image processing pipeline and a third image processing pipeline is constructed as the at least one image processing pipeline.

According to an embodiment of the present application, the inference pipeline may be constructed such that a computer vision-based model that performs the structured vision task inference is executed on the at least one image processing pipeline, and a vision-language model that performs the unstructured vision task inference is executed as the general-purpose inference model.

According to an embodiment of the present application, a non-transitory computer-readable recording medium having a program recorded thereon for executing the method for constructing the inference pipeline may be provided.

An electronic device for constructing an inference pipeline for multi-modal analysis by industry domain according to an embodiment of the present application may comprise: a memory; and a processor, wherein the processor may be configured to: obtain an image processing pipeline package and an inference engine for multi-modal analysis, wherein the inference engine includes a domain agnostic general-purpose inference model and an industry domain-adaptive data processing logic; obtain, through a client terminal, a setting command for a target rule set related to a specific industry domain among a plurality of rule sets compatible with the inference engine, wherein each of the rule sets defines an inference requirement for a structured vision task for an unstructured vision task inference using the general-purpose inference model with respect to an industry domain; obtain, from the image processing pipeline package, at least one image processing pipeline that satisfies the inference requirement of the target rule set, based on the setting command for the target rule set; and construct the inference pipeline based on the at least one image processing pipeline and the inference engine.

A method for analyzing an event according to an embodiment of the present application may comprise: receiving a video stream; receiving constraint information for analysis; performing first processing on the video stream using at least one first model, wherein the first model is configured to perform the first processing with reference to the constraint information and to output a first data set; generating a query to be input to a second model by performing second processing on the first data set with reference to the constraint information; querying the second model, which generates an output in text form, based on the generated query; performing third processing on the output generated through the second model with reference to the constraint information; and generating event information based on a result of the first processing and a result of the third processing.

According to an embodiment of the present application, the constraint information may include at least one of: a constraint identifier; first information regarding a parameter of the first model for configuring the first data set; second information regarding a query template associated with the constraint identifier; third information configured to generate the query based on the query template and the first data set; and fourth information regarding a parser associated with the constraint identifier.

According to an embodiment of the present application, generating the query may further comprise: receiving a target query template to be used for analysis with reference to the second information of the constraint information; and generating the query by computing a value for a variable included in the target query template based on the first data set, with reference to the third information of the constraint information.

According to an embodiment of the present application, performing the third processing on the output generated through the second model may further comprise: receiving a target parser to be used for analysis with reference to the fourth information of the constraint information; and parsing the output generated through the second model using the target parser.

According to an embodiment of the present application, the event information may include at least one of: a video used for analysis; an embedding or a metric related to the result of the first processing; a type of event detected by the third processing; and the constraint information.

According to an embodiment of the present application, the first data set may comprise a constraint identifier, object-based metadata, analysis data generated by the first model, and a video used for analysis.

According to an embodiment of the present application, the second model may be a multi-modal model matched as a model to which the query is to be input, with reference to the constraint identifier included in the first data set.

According to an embodiment of the present application, performing the first processing may further comprise determining a first candidate image for an image corresponding to a start time of an action of interest and a second candidate image for an image corresponding to an end time of the action of interest; and generating the query may further comprise generating the query based on the first candidate image and the second candidate image.

According to an embodiment of the present application, generating the query based on the first candidate image and the second candidate image may further comprise: generating a first query for querying the start of the action of interest based on the first candidate image; and generating a second query for querying the end of the action of interest based on the second candidate image.

According to an embodiment of the present application, the second candidate image may be determined as an image at a time at which a predetermined time has elapsed from a time corresponding to the first candidate image, or may be determined based on a change of the second candidate image with respect to the first candidate image.

According to an embodiment of the present application, querying the second model may further comprise: inputting the first candidate image and the first query as a first input value of the second model; and inputting the second candidate image and the second query as a second input value of the second model.

According to an embodiment of the present application, the second model may be configured to output that an event of interest has occurred when a first response to the first input value and a second response to the second input value correspond to a predetermined response combination.

According to an embodiment of the present application, performing the first processing may further comprise obtaining field-of-view information of a camera that captured the video stream; and generating the query may further comprise: receiving a plurality of candidate queries, wherein each of the plurality of candidate queries is a query previously matched according to a camera field of view; and determining, as a target query, a query matched with the field-of-view information from among the plurality of candidate queries based on the field-of-view information.

According to an embodiment of the present application, performing the first processing may further comprise: obtaining a reference image for a normal situation; comparing, through the first model, the reference image with a current image of the video stream; and determining, based on a result of the comparison, that the current image is a candidate image for an abnormal situation that is not the normal situation; and generating the query may further comprise generating the query based on the candidate image.

According to an embodiment of the present application, generating the query may further comprise: determining a region of interest in which a difference exists by comparing pixels included in the reference image with pixels included in the candidate image for the abnormal situation; and generating the query based on a cropped image including the region of interest.

According to an embodiment of the present application, performing the first processing may comprise: identifying a situation in which at least one object is located in a region of interest based on the video stream; and generating a cropped image including the region of interest and the at least one object related to the identified situation; and generating the query may further comprise generating the query based on the cropped image.

According to an embodiment of the present application, performing the first processing may comprise obtaining direction information of at least one object based on the video stream; and generating the query may further comprise: generating the query based on a third query corresponding to first direction information when the direction information of the object includes the first direction information; and generating the query based on a fourth query corresponding to second direction information when the direction information of the object includes the second direction information that is different from the first direction information.

According to an embodiment of the present application, performing the first processing may comprise: identifying a situation in which at least one object that has been moving has come to a stop based on the video stream; and generating a cropped image including the at least one object related to the identified situation; and generating the query may further comprise generating, as a target query, a query corresponding to the situation of having come to a stop based on the cropped image.

According to an embodiment of the present application, performing the first processing may comprise: identifying a situation in which at least two or more objects are present based on the video stream; and generating a cropped image including the at least two or more objects; and generating the query may further comprise generating the query based on at least one of an identifier for each of the at least two or more objects, object information, the number of objects, and the cropped image.

According to an embodiment of the present application, performing the first processing may further comprise computing a confidence for a part of interest of an object present in the video stream using a pose estimation technique; and generating the query may further comprise receiving a cropped image of the part of interest and generating a query related to the wearing of protective gear on the part of interest, when the computed confidence is greater than a predetermined threshold.

According to an embodiment of the present application, a non-transitory computer-readable recording medium having a program recorded thereon for executing the method for analyzing an event may be provided.

An electronic device for analyzing an event based on a video stream according to an embodiment of the present application may comprise: a memory; and a processor, wherein the processor may be configured to: receive the video stream; receive constraint information for analysis; perform first processing on the video stream using at least one first model, wherein the first model is configured to perform the first processing with reference to the constraint information and to output a first data set; generate a query to be input to a second model by performing second processing on the first data set with reference to the constraint information; query the second model, which generates an output in text form, based on the generated query; perform third processing on the output generated through the second model with reference to the constraint information; and generate event information based on a result of the first processing and a result of the third processing.

A method for providing information about an event using a vision-language model according to an embodiment of the present application may comprise: obtaining first image-based information based on a first rule, and generating a first query regarding whether an event has occurred based on the first image-based information; transmitting the first query to the vision-language model so that whether the event has occurred is determined by the vision-language model; after determining that the event has occurred based on an output of the vision-language model, providing information that the event has occurred; after determining that the event has occurred, obtaining second image-based information based on a second rule, and generating a second query regarding whether the event has ended based on the second image-based information; transmitting the second query to the vision-language model so that whether the event has ended is determined by the vision-language model; and after determining that the event has ended based on an output of the vision-language model, providing information that the event has ended.

According to an embodiment of the present application, generating the second query regarding whether the event has ended may further comprise: after determining that the event has occurred, generating a third query for confirming whether an action responsive to event occurrence is being performed based on a third rule; transmitting the third query to the vision-language model so that whether the action responsive to event occurrence is being performed is determined by the vision-language model; and after determining that the action responsive to event occurrence is being performed based on the output of the vision-language model, providing information that the action responsive to event occurrence is being performed.

According to an embodiment of the present application, the second query may be generated after obtaining, in response to the third query, the information that the action responsive to event occurrence is being performed.

According to an embodiment of the present application, the second query is generated at least once and transmitted to the vision-language model for a first time interval included between a time at which the event is determined to have occurred and a time at which the event is determined to have ended; the third query is generated at least once and transmitted to the vision-language model for a second time interval included between the time at which the event is determined to have occurred and the time at which the event is determined to have ended; and the first time interval and the second time interval may at least partially overlap with each other.

According to an embodiment of the present application, generating the second query may further comprise: in response to determining that the action responsive to event occurrence is being performed, obtaining the second image-based information based on the second rule, and generating the second query using the second image-based information as a first input and the information that the action responsive to event occurrence is being performed in a third image-based information as a second input.

According to an embodiment of the present application, the method may further comprise: in response to determining that the event has ended, ceasing the querying of the vision-language model with the second query and the third query, and regenerating the first query regarding whether the event has occurred and querying the vision-language model with the regenerated first query.

According to an embodiment of the present application, the method may further comprise: in response to determining that the action responsive to event occurrence is being performed, ceasing the querying of the vision-language model with the third query while maintaining the querying of the vision-language model with the second query.

According to an embodiment of the present application, the first query may be transmitted to the vision-language model at a predetermined first time period; and the second query or the third query may be transmitted to the vision-language model at a predetermined second time period that is different from the first time period.

According to an embodiment of the present application, the first time period may be shorter than the second time period.

According to an embodiment of the present application, providing the information that the event has ended may further comprise: obtaining an event end time at which the event is determined to have ended based on the output of the vision-language model; and outputting the information that the event has ended at a time at which a predetermined time has elapsed from the event end time.

According to an embodiment of the present application, the method may further comprise: when it is determined that an event has occurred again between the event end time and the time at which the predetermined time has elapsed, maintaining the providing of the information that the event has occurred without outputting the information that the event has ended.

According to an embodiment of the present application, the method may further comprise: when it is determined that an event has occurred again between the event end time and the time at which the predetermined time has elapsed, maintaining the querying of the vision-language model with the second query during the predetermined time, or generating a fourth query regarding whether the event has started again and querying the vision-language model with the fourth query.

According to an embodiment of the present application, the event may be configured to be determined to have ended after end of the event has been detected for a predetermined number of times based on the second query and the output of the vision-language model.

According to an embodiment of the present application, the first query may comprise a plurality of sub-queries, and the event may be configured to be determined to have occurred when occurrence of the event is detected for at least one sub-query among the plurality of sub-queries.

According to an embodiment of the present application, the method may further comprise: providing information indicating a normal situation during a first progress status interval that includes at least a part between a time at which the first query is generated and the time at which the event is determined to have occurred; providing information indicating that an action with respect to the event is yet to be started during a second progress status interval that includes at least a part between a time at which the third query is generated and a time at which the action responsive to event occurrence is determined to be being performed; and providing information indicating that the action with respect to the event is being performed during a third progress status interval that includes at least a part between a time at which the second query is generated and the time at which the event is determined to have ended.

According to an embodiment of the present application, generating the first query regarding whether the event has occurred may further comprise obtaining the first image-based information from a first media processing pipeline corresponding to the first rule; generating the second query regarding whether the event has ended may comprise obtaining the second image-based information from a second media processing pipeline corresponding to the second rule; and at least one model that is different from a model executed in the first media processing pipeline may be executed in the second media processing pipeline.

According to an embodiment of the present application, the method may further comprise: after determining that the event has occurred, storing event information, wherein the event information comprises information regarding at least one of an identifier for a channel that captured an image used to analyze the event, a unique identifier (UUID), an event type, an identifier for a query input to the vision-language model, a time to live (TTL) for the event information, a risk level of the event, and a progress status of the event.

According to an embodiment of the present application, generating the second query may further comprise: determining a change of the first rule to the second rule with reference to the progress status of the event in the event information; and generating, in accordance with the change, the second query whose performance has been verified in advance with respect to the second rule.

According to an embodiment of the present application, the second query may be generated to have a chain prompt form together with the first query.

According to an embodiment of the present application, the method may further comprise: after determining that the event has ended, updating at least one of the identifier for the query, the risk level, the time to live, and the progress status included in the event information.

According to an embodiment of the present application, a non-transitory computer-readable recording medium having a program recorded thereon for executing the method for providing information an event may be provided.

An electronic device for analyzing information about an event based on image-based information using a vision-language model according to an embodiment of the present application may comprise: a memory; and a processor, wherein the processor may be configured to: obtain first image-based information based on a first rule, and generate a first query regarding whether an event has occurred based on the first image-based information; transmit the first query to the vision-language model so that whether the event has occurred is determined by the vision-language model; after determining that an event has occurred based on an output of the vision-language model, provide information that the event has occurred; after determining that the event has occurred, obtain second image-based information based on a second rule, and generate a second query regarding whether the event has ended based on the second image-based information; transmit the second query to the vision-language model so that whether the event has ended is determined by the vision-language model; and after determining that the event has ended based on an output of the vision-language model, provide information that the event has ended.

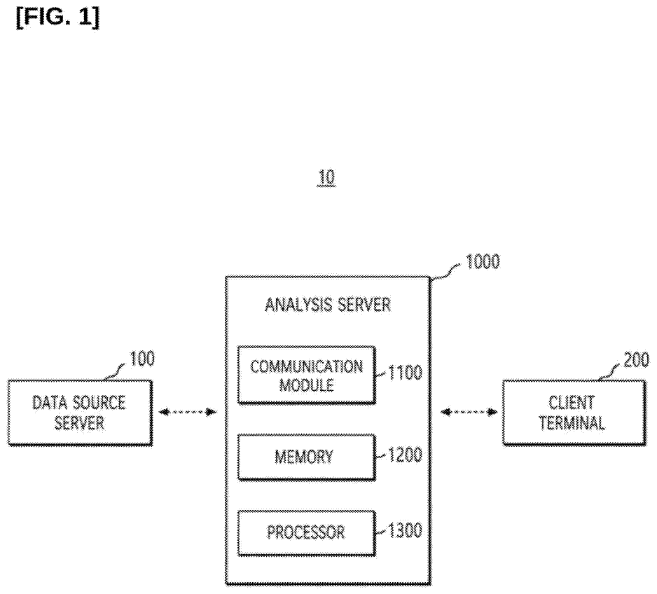

Hereinafter, with reference to FIGS. 1 to 25, a method for constructing a pipeline for event analysis, a method for analyzing an event using an inference pipeline (analysis pipeline), a method for providing information about an event, an analysis server for performing the same, and an event analysis system according to an embodiment of the present application will be described in more detail.

The event analysis system according to an embodiment of the present application may be configured to perform operations of constructing an inference pipeline for image-based event detection, analyzing an event using the constructed inference pipeline, and providing information about the event.

FIG. 1 is a schematic diagram illustrating an event analysis system 10 according to an embodiment of the present application.

The event analysis system 10 according to an embodiment of the present application may include a data source server 100, a client terminal 200, and/or an analysis server 1000.

The data source server 100 may serve to supply a data source to be analyzed by the analysis server 1000 of the event analysis system 10. The data source server 100 may be configured to transmit image data (a video sequence) collected from a camera or a sensor installed at a specific site to the analysis server 1000. Here, “site” refers to a physical location or a management unit, and may be, for example, a construction site, a manufacturing plant, a specific point for traffic control, or the like. The data source may include a real-time video stream (e.g., streaming via the RTSP protocol), a stored video file, an image sequence, and/or other forms of image data.

The client terminal 200 is a device used by a user (administrator) to construct and manage the inference pipeline. The client terminal 200 provides a graphical user interface (GUI), through which the user may input various setting commands related to construction of the inference pipeline and transmit the setting commands to the analysis server 1000. The client terminal 200 may be implemented as various types of computing devices, such as a desktop computer, a notebook, or a tablet. Specifically, the client terminal 200 may be implemented through a GUI-based installable operation tool. Such an operation tool is used by the user to install and manage the artificial intelligence-based event analysis system 10, and may be configured to perform various tasks such as server and channel connection, configuration of an image processing pipeline package, an artificial intelligence model, and an inference model, and/or rule configuration.

The analysis server 1000 may perform operations of constructing and executing an inference pipeline for multi-modal analysis. Specifically, the analysis server 1000 communicates with the client terminal 200 and may configure the inference pipeline based on a setting command received from the client terminal 200. According to an embodiment, at least one agent module is installed in the analysis server 1000. The agent module may receive commands, settings, and/or data transmitted from the client terminal 200, and may distribute them to appropriate components within the analysis server 1000 (a resource monitoring module, a container management module, a log collection module, a rule management module, and the like). In addition, the agent module may serve to synchronize the analysis server 1000 with the client terminal 200 by serializing processing results or status information of the analysis server 1000 in real time and transmitting them to the client terminal 200.

Through such a structure, the user may easily perform a complex inference pipeline construction task through the intuitive GUI of the client terminal 200, and the agent module of the analysis server 1000 may stably link such tasks with various components within the analysis server 1000.

The analysis server 1000 may be a server, an edge device, a PC, a tablet PC, a smart phone, a smart watch, a PDA, and/or a combination thereof in any form. Furthermore, the analysis server 1000 may have a meaning encompassing a combination of at least one or more servers. At least one or more agents for constructing the inference pipeline and the inference pipeline may be executed on the analysis server 1000.

The analysis server 1000 may include a communication module 1100, a memory 1200, and/or a processor 1300.

The communication module 1100 of the analysis server 1000 may communicate with any external device or external server. As an example, the analysis server 1000 may receive, through the communication module 1100, a video sequence to be analyzed from the data source server 100. As an example, the analysis server 1000 may communicate with the client terminal 200 through the communication module 1100, may receive any setting command related to pipeline construction from the client terminal 200, or may transmit any data and/or commands related to pipeline construction to the client terminal 200. As an example, the analysis server 1000 may obtain, through the communication module 1100, any data (e.g., structure information, an operation library, parameter information, prompt information, and the like of each model) for executing a first model and/or an inference model (a second model) to be executed on the constructed inference pipeline. As an example, the analysis server 1000 may transmit any event information that is an analysis result using the inference pipeline to any external device including the client terminal 200. However, this is merely an example, and the analysis server 1000 may transmit and receive any appropriate data and/or commands to and from any component through the communication module 1100.

The analysis server 1000 may access a network through the communication module 1100 to transmit and receive various data. The communication module 1100 may broadly include a wired type and a wireless type. Since the wired type and the wireless type each have advantages and disadvantages, the analysis server 1000 may, in some cases, be provided with both the wired type and the wireless type. Here, in the case of the wireless type, a WLAN (Wireless Local Area Network)-based communication scheme such as Wi-Fi may primarily be used. Alternatively, in the case of the wireless type, a cellular communication scheme such as LTE or 5G may be used. However, the wireless communication protocol is not limited to the above-described examples, and any appropriate wireless type communication scheme may also be used. In the case of the wired type, LAN (Local Area Network) or USB (Universal Serial Bus) communication is a representative example, and other schemes are also possible.

The memory 1200 of the analysis server 1000 may store various information. Various data may be stored temporarily or semi-permanently in the memory 1200. Examples of the memory 1200 may include a hard disk drive (HDD), a solid state drive (SSD), a flash memory, a read-only memory (ROM), a random access memory (RAM), and the like. The memory 1200 may be provided in a form embedded in the analysis server 1000 or in a detachable form. The memory 1200 may store an operating system (OS) for driving the analysis server 1000, programs for operating each component of the analysis server 1000, and various data necessary for the operation of the analysis server 1000.

The processor 1300 may control the overall operation of the analysis server 1000. For example, the processor 1300 may control the overall operation of the analysis server 1000, including operations of constructing the inference pipeline to be described later, performing analysis on an event using the constructed inference pipeline, and/or displaying or providing event information. Specifically, the processor 1300 may load and execute a program for the overall operation of the analysis server 1000 from the memory 1200. The processor 1300 may be implemented as an application processor (AP), a central processing unit (CPU), a microcontroller unit (MCU), or a similar device, depending on hardware, software, or a combination thereof. In this case, in terms of hardware, the processor 1300 may be provided in the form of an electronic circuit that processes electrical signals to perform a control function, and in terms of software, may be provided in the form of a program or code for driving a hardware circuit. For example, the processor 1300 may be provided in the form of processing circuitry.

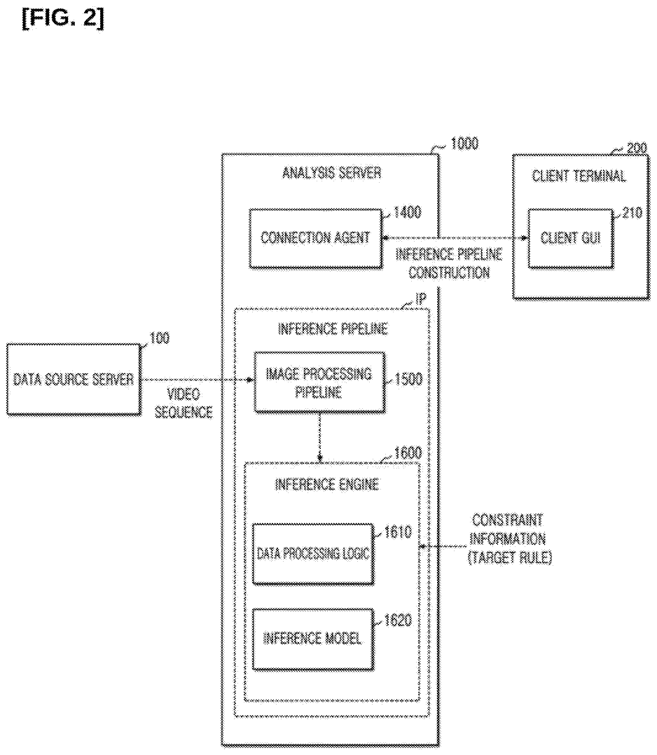

FIG. 2 is a diagram illustrating a detailed configuration of the analysis server 1000 and a structure of the inference pipeline according to an embodiment of the present invention.

Referring to FIG. 2, the analysis server 1000 may include a connection agent 1400 and an inference pipeline (IP), and the client terminal 200 may include a client GUI 210.

The operation flow of the event analysis system 10 of the present invention is briefly described as follows.

First, the user may perform various settings necessary for constructing the inference pipeline through the client GUI 210 of the client terminal 200. Such settings include server connection, channel registration, image processing pipeline package configuration, artificial intelligence model/general-purpose inference model configuration, and/or rule configuration (constraint configuration). The client GUI 210 provides an intuitive graphical interface to support the user in easily performing complex pipeline construction tasks.

The setting command input by the user may be transmitted from the client terminal 200 to the connection agent 1400 of the analysis server 1000. The connection agent 1400 serves to deliver the setting command received from the client terminal 200 to an appropriate component within the analysis server 1000.

The analysis server 1000 may perform an operation of constructing the inference pipeline (IP) based on the received setting command. In the process of constructing the inference pipeline (IP), an image processing pipeline 1500 may be configured based on a target rule (which may also be referred to as constraint information) generated according to a value setting for a rule item belonging to the rule set selected by the user.

Once the inference pipeline (IP) is constructed, the analysis server 1000 may receive a video stream (a video sequence) from the data source server 100 and perform analysis. Specifically, the constructed inference pipeline (IP) may be implemented to perform analysis for detecting an event present in the video sequence received from the data source server 100, using the determined target rule (constraint information).

The inference pipeline (IP) according to an embodiment of the present application may include the image processing pipeline 1500 and/or an inference engine 1600 including a data processing logic 1610 and an inference model 1620.

The image processing pipeline 1500 may be an intelligent media pipeline that receives various types of input data sources (a video stream, an image, a video clip, and the like) and processes them into a form suitable for artificial intelligence analysis. The image processing pipeline 1500 may be implemented to perform functions such as video decoding, analysis using a computer vision(hereinafter referred to as “CV”)-based artificial intelligence model (e.g., a structured vision task such as object detection, segmentation, and classification), metadata extraction, and/or video encoding.

The inference engine 1600 may include the data processing logic 1610 and the inference model 1620.

The data processing logic 1610 is a logic that performs industry domain-adaptive data processing, and may be configured to operate together with the inference model 1620, which is a domain agnostic general-purpose inference model. The data processing logic 1610 may perform operations of generating a query to be input to the inference model 1620 based on data received from the image processing pipeline 1500, and processing an output of the inference model 1620 to generate event information.

The inference model 1620 is a general-purpose inference model that performs unstructured vision task inference, and may be implemented as a multi-modal model including a vision-language model (VLM). The inference model 1620 may be configured to receive an image and a text-form query as inputs and generate a response in natural language form. The inference model 1620 enables determination of various unstructured events that the image processing pipeline has not previously learned.

Meanwhile, the constraint information (target rule) determined in the process of constructing the inference pipeline (IP) plays an important role throughout event analysis. The image processing pipeline 1500 may be constructed to perform first processing with reference to the constraint information, and the data processing logic 1610 may be constructed to perform second processing (query generation) and third processing (parsing of the output of the inference model 1620) with reference to the constraint information.

Through such a structure, even with the image processing pipeline 1500 that performs structured tasks, by changing only the constraint information (target rule), it becomes possible to adapt to analysis tasks of various industry domains. For example, when constraint information related to industrial safety is applied, whether PPE is being worn may be detected, and when constraint information related to traffic is applied, a traffic accident event may be detected, thereby enabling various event analyses without retraining the model.

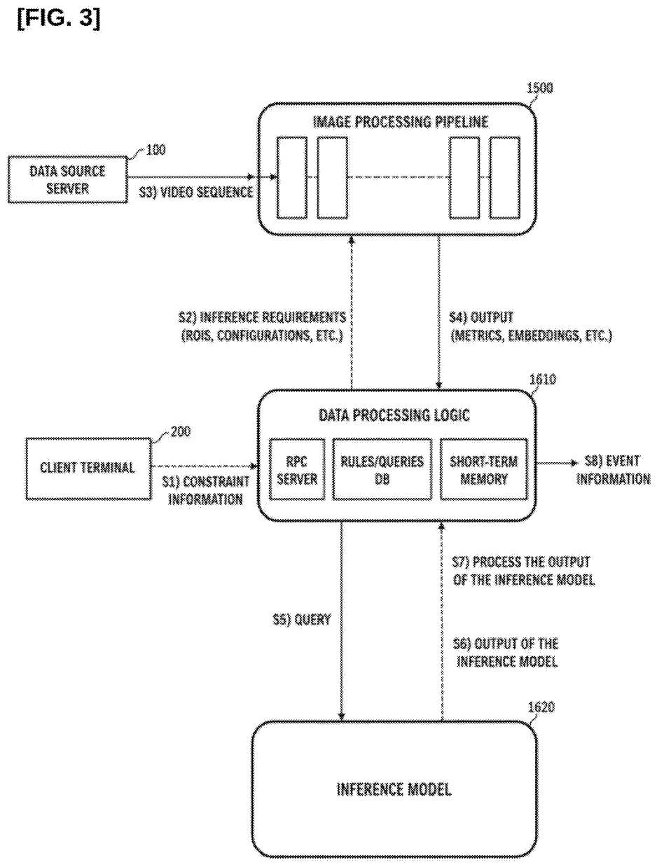

FIG. 3 is a diagram for explaining an aspect of event analysis performed by the event analysis system 10 according to an embodiment of the present application. Specifically, FIG. 3 is a diagram illustrating a process of constructing the inference pipeline (IP) and analyzing an event using the inference pipeline (IP) according to an embodiment of the present invention.

The construction of the inference pipeline and the event analysis according to the present invention proceed in the following order:

### S1) Receiving Constraint Information

The data processing logic 1610 of the analysis server 1000 may obtain constraint information from the client terminal 200. The constraint information may be generated based on a rule set and a rule configured by the user through the client GUI, and the constraint information may include a constraint identifier (e.g., a rule set identifier, a rule identifier), first information for configuration of the image processing pipeline, second information regarding a query template, third information regarding a query generation logic, and/or fourth information regarding a parser for processing the output of the inference model 1620. The received constraint information may be used to construct the inference pipeline or to analyze an event.

### S2) Linking the Image Processing Pipeline based on Inference Requirements

The data processing logic 1610 may be configured to determine inference requirements at the image processing pipeline 1500 based on the constraint information, and to deliver them to the image processing pipeline 1500. The inference requirements are information defining how the image processing pipeline 1500 should be configured and operate, and what form of data should be output.

According to an embodiment, the data processing logic 1610 may be implemented to deliver, to the image processing pipeline, inference requirements including the type and number of artificial intelligence models to be executed in the image processing pipeline 1500, requirements for tasks to be performed, region of interest information, a confidence threshold, parameters for crop, padding, frame drop rate, and/or frame interval, and/or types of objects to be detected, thereby linking the image processing pipeline 1500 and the inference engine 1600 with each other. Furthermore, the inference requirements may further include the type of computer vision tasks such as object detection, segmentation, classification, object tracking, and/or pose estimation corresponding to a specific unstructured task within a specific industry domain, the type of pre-trained computer vision models, and/or limitations on training data.

The image processing pipeline 1500 sets its internal configuration according to the received inference requirements.

### S3) Receiving the Video Sequence and Performing First Processing

After the inference pipeline is constructed, the image processing pipeline 1500 may receive a video sequence from the data source server 100. The video sequence may be in various forms, such as a real-time RTSP stream, a stored video file, or an image sequence, and may be a video sequence for a specific channel connected during the inference pipeline construction process.

The image processing pipeline 1500 may perform first processing on the received video sequence. The first processing is performed with reference to the constraint information, and the first processing may be performed by structured vision task inference using a computer vision-based artificial intelligence model.

Examples of structured vision tasks that may be performed in the first processing are as follows: Object Detection: A task of detecting objects such as people, vehicles, and equipment in an image. Segmentation: A task of dividing the boundary of an object in an image at the pixel level. Classification: A task of classifying detected objects into detailed categories (e.g., wearing/not wearing a safety helmet). Object Tracking: A task of tracking the same object across consecutive frames to identify movement paths. Pose Estimation: A task of representing the posture of an object as keypoints to identify the locations of body parts.

### S4) Generating an Output of the Image Processing Pipeline 1500

As a result of the first processing, the image processing pipeline 1500 may generate an output through an artificial intelligence model (the first model) executed in the image processing pipeline 1500, and the output of the first model may include object-based metadata and/or analysis data.

The object-based metadata is raw data extracted through the first processing, and may include bounding box coordinates, a class identifier related to the category of a detected object, a confidence score, a segmentation mask, keypoint coordinates and confidence, and/or a tracking identifier.

The analysis data is high-level information extracted for a specific industry domain by processing the metadata, and may include a metric, an embedding (which is data representing the characteristics of an object in vector form), an original image or a cropped image used for the analysis, and/or a constraint identifier (a rule set identifier and/or a rule identifier) indicating by which rule processing has been performed.

Meanwhile, the image processing pipeline 1500 may be configured to output a data set having a specific structure with reference to the constraint information.

### S5) Generating a Query

The data processing logic 1610 may be implemented to generate a query to be input to the inference model 1620 of the inference engine 1600 with reference to the constraint information. This process corresponds to the second processing and proceeds in the following sub-steps:
S5-1) Obtaining the Query Template: The data processing logic 1610 may obtain, from the Rules/Queries DB, a query template corresponding to a constraint identifier (rule identifier). The query template is composed of natural-language question forms including variables.
S5-2) Computing Variables: The data processing logic 1610 may be implemented to compute variables of the query template using the metadata and analysis data included in the output of the image processing pipeline 1500, with reference to the constraint information.
S5-3) Generating the Query: The data processing logic 1610 may be implemented to generate the query to be input to the inference model 1620 of the inference engine 1600 by replacing variables in the query template with the computed values. In particular, the generated query may be input to the inference model 1620 together with the image used for the analysis (or the cropped image).

### S6) Generating an Output through the Inference Model

The inference model 1620 may be configured to receive the query and the image from the data processing logic 1610, perform unstructured vision task inference, and generate an output in text form.

The inference model 1620 may be implemented as a multi-modal model including a vision-language model (VLM), and is capable of understanding and making determinations based on the context of images and text even with respect to various situations that the image processing pipeline has not previously learned.

The output of the inference model 1620 may be returned to the data processing logic 1610 for subsequent processing.

### S7) Processing the Inference Model Output

The data processing logic 1610 may be implemented to process the output returned through the inference model 1620. This process corresponds to the third processing and may proceed in the following sub-steps:
S7-1) Obtaining and Parsing with the Parser: The data processing logic 1610 may be implemented to obtain parser information corresponding to the constraint identifier (rule identifier) from the Rules/Queries DB, and to parse the natural-language output of the inference model into structured data using a target parser corresponding to the parser information.
S7-2) Combining Results: The data processing logic 1610 may be implemented to combine the result of parsing the output of the inference model 1620 through the target parser with the output of the image processing pipeline 1500 (e.g., the metric, embedding, metadata, and the like). Through this, the result of the structured vision task and the result of the unstructured vision task are integrated.
S7-3) Determining the Event: The data processing logic 1610 may determine whether an event has occurred based on the combined information.

### S8) Generating Event Information

The data processing logic 1610 may be implemented to generate event information based on the processing result of S7. The event information is generated in a structured form, and may include at least one of the following information:
1) Basic information: Channel identifier: The ID of the channel (camera) at which the event occurred. Unique identifier (UUID): An ID that uniquely identifies the event. Event type: The category of the detected event (e.g., “PPE not worn,” “collision risk,” “fire,” and the like). Timestamp: The time at which the event occurred.
2) Analysis data: A video or image used for the analysis. An embedding or a metric related to the result of the first processing. Object-based metadata (bounding box, class, confidence, and the like).
3) Constraint information: A rule set identifier. A rule identifier. An identifier for the applied query.
4) Event attributes: Risk level: A score or level indicating the severity of the event. Progress status: The current stage of the event (e.g., “event occurrence,” “event being addressed,” “event ended,” and the like). Time to live (TTL): A period for which the event information is to be retained in memory.

Meanwhile, the generated event information may be delivered to the client terminal 200 and displayed in real time to the user through the client GUI, thereby allowing the user to monitor the on-site situation and respond promptly.

In addition, the generated event information may be stored in a short-term memory of the data processing logic 1610 to be utilized as context information in subsequent event analyses. The stored events may be retained until the time to live (TTL) elapses or they are explicitly deleted.

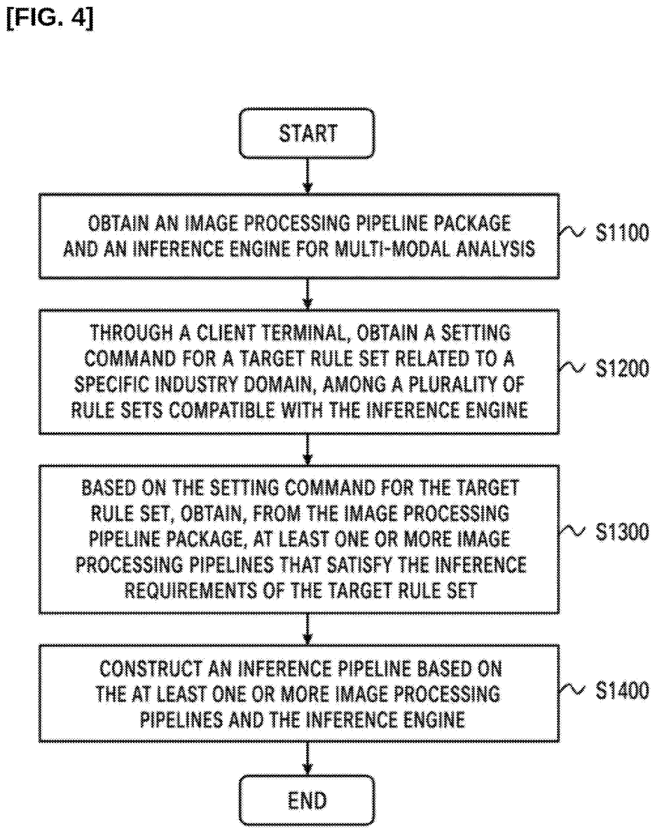

Hereinafter, with reference to FIGS. 4 to 18, the method for constructing the inference pipeline and/or the method for analyzing an event using the inference pipeline according to an embodiment of the present application will be described in more detail.

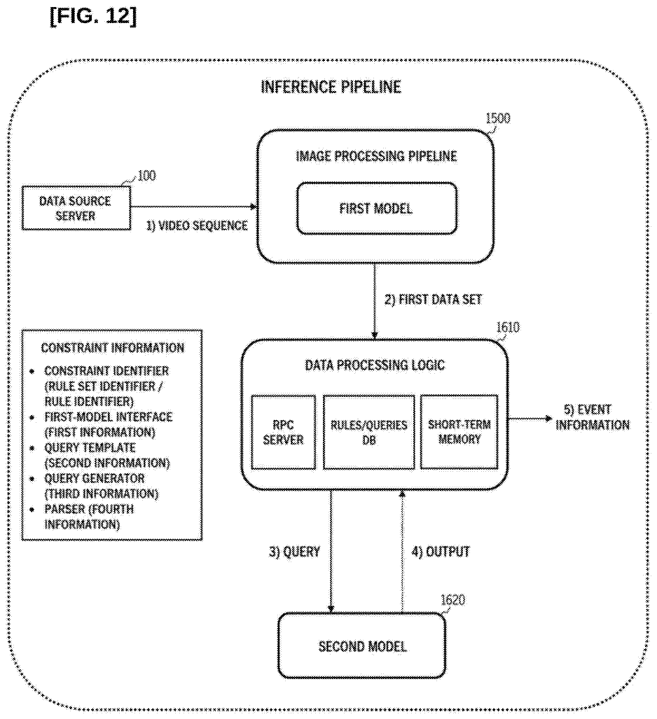

Specifically, with reference to FIGS. 4 to 11, the method for constructing the inference pipeline will be described in more detail, and with reference to FIGS. 12 to 18, the method for analyzing an event using the inference pipeline according to an embodiment of the present application will be described in more detail.

Meanwhile, in describing the method for constructing the inference pipeline and/or the method for analyzing an event using the inference pipeline, some embodiments overlapping with the contents previously described with reference to FIGS. 1 to 3 may be omitted. However, this is merely for the convenience of explanation, and should not be construed as limiting.

FIG. 4 is a flowchart illustrating a method for constructing the inference pipeline (analysis pipeline) according to an embodiment of the present application. The method for constructing the inference pipeline according to FIG. 4 may be performed by the analysis server 1000 communicating with the client terminal 200.

The method for constructing the inference pipeline according to an embodiment of the present application may include: a step (S1100) of obtaining an image processing pipeline package and an inference engine for multi-modal analysis; a step (S1200) of obtaining, through a client terminal, a setting command for a target rule set related to a specific industry domain among a plurality of rule sets compatible with the inference engine; a step (S1300) of obtaining, from the image processing pipeline package, at least one image processing pipeline that satisfies an inference requirement of the target rule set, based on the setting command for the target rule set; and/or a step (S1400) of constructing the inference pipeline based on the at least one image processing pipeline and the inference engine.

In the step (S1100) of obtaining the image processing pipeline package and the inference engine for multi-modal analysis, the analysis server 1000 may obtain the image processing pipeline package and the inference engine for multi-modal analysis.

The image processing pipeline package is a set of pipelines that receive various types of input data sources (a video stream, an image, a video clip, and the like) and process them into a form suitable for artificial intelligence analysis. Each image processing pipeline included in the image processing pipeline package may perform functions such as video decoding, AI model-based analysis, metadata extraction, and/or video encoding.

The inference engine 1600 may include a domain agnostic general-purpose inference model 1620 and an industry domain-adaptive data processing logic 1610. The general-purpose inference model 1620 is a model capable of performing unstructured vision tasks of various industry domains without being limited to a specific industry domain, and may be implemented as a vision-language model (VLM). The industry domain-adaptive data processing logic 1610 may include logic for preprocessing data to be input to the general-purpose inference model 1620 and post-processing the output of the general-purpose inference model 1620, so that the general-purpose inference model 1620 can be utilized in accordance with analysis requirements of a specific industry domain.

The image processing pipeline package and/or the general-purpose inference model 1620 of the inference engine 1600 obtained by the analysis server 1000 in the step S1100 are characterized in being selected in a form optimized for the hardware specification of the server on which analysis is to be performed.

Specifically, the image processing pipeline package may be selected, from a pipeline pool including a plurality of image processing pipelines optimized for different hardware, as at least one image processing pipeline whose performance has been verified for the hardware specification information of the server on which analysis is to be performed. In the present invention, the hardware on which the analysis is to be performed is selected first, and the image processing pipeline is selected in consideration of the specifications of the corresponding hardware. This is because there exist image processing and analysis SDKs that can optimize operations for each piece of hardware, and pipelines optimized for the hardware should be configured by utilizing such SDKs. Accordingly, the image processing pipelines may be managed and constructed in a form optimized for each piece of hardware.

As an example, the pipeline pool may include image processing pipelines suitable for the following types of hardware: A pipeline for NVIDIA GPUs: built based on the NVIDIA DeepStream SDK, optimized to maximally utilize CUDA cores and Tensor cores. Suitable for data center-class GPUs such as NVIDIA Blackwell or edge devices such as the Jetson series. A pipeline for Qualcomm processors: built using the Qualcomm IM SDK, optimized to utilize Qualcomm hardware accelerators. A pipeline for general-purpose NPUs: built based on a custom plugin utilizing general-purpose image processing frameworks such as gstreamer and opencv, for NPUs such as the IMX 500, NXP, or other low-spec processors.

In this case, the client terminal 200 may be implemented to check the hardware specification information of the server on which the analysis is to be performed (e.g., the GPU model name, CPU architecture, type of media accelerator, and the like), and to select, from the pipeline pool, an image processing pipeline package whose performance has been verified for hardware corresponding to the hardware specification information, and to provide it to the user. The hardware specification information may be computed by the analysis server 1000 based on server information (e.g., the server name, IP address, and port number) obtained through a server adding function via the client terminal 200, and may be transmitted to the client terminal 200. The hardware specification information serves as a key criterion for selecting the type of the image processing pipeline 1500 and/or the inference engine 1600 to be installed on the analysis server 1000.

For example, in the case of an NVIDIA GPU, a DeepStream SDK-based pipeline may be selected; in the case of a Qualcomm processor, a pipeline utilizing the IM SDK may be selected. In addition, in the case of the IMX 500, NXP, or other NPUs, when there is an SDK available for the corresponding hardware, the SDK is utilized; when there is none, a custom plugin-based pipeline utilizing general-purpose image processing frameworks such as gstreamer and opencv may be selected as a pipeline whose performance has been verified. Specifically, if an NVIDIA Blackwell GPU is mounted on the server on which the analysis is to be performed, a high-performance pipeline package based on the DeepStream SDK may be selected, and the inference pipeline may be constructed to process a large-volume video stream in real time. If the server is an edge server equipped with the Jetson series, a lightweight DeepStream-based pipeline package optimized for a low-power environment may be selected, and the inference pipeline may be constructed accordingly.

In the step (S1200) of obtaining, through the client terminal, a setting command for the target rule set related to the specific industry domain among the plurality of rule sets compatible with the inference engine, the analysis server 1000 may obtain, through the client terminal 200, a setting command for the target rule set related to a specific industry domain among a plurality of rule sets compatible with the inference engine 1600.

A rule set defines the inference requirement for a structured vision task to be performed in the image processing pipeline 1500 for unstructured vision task inference using the general-purpose inference model 1620 with respect to a specific industry domain. One or more rule sets may be generated for each industry domain, and may be configured according to the characteristics of the events to be detected in the corresponding industry domain.

The inference requirement of each rule set may include a type of structured vision inference tasks corresponding to one of a plurality of unstructured vision inference tasks predefined within one industry domain. The type of structured vision inference tasks may include at least one of object detection, segmentation, classification, object tracking, and pose estimation.

In addition, each rule set may include a rule item and a user-modifiable parameter for generating the input data of the general-purpose inference model 1620 from the output of the image processing pipeline 1500 included in the image processing pipeline package for each industry domain. Through input of setting values for such modifiable parameters, the user may finely adjust the inference pipeline (IP) according to on-site conditions.

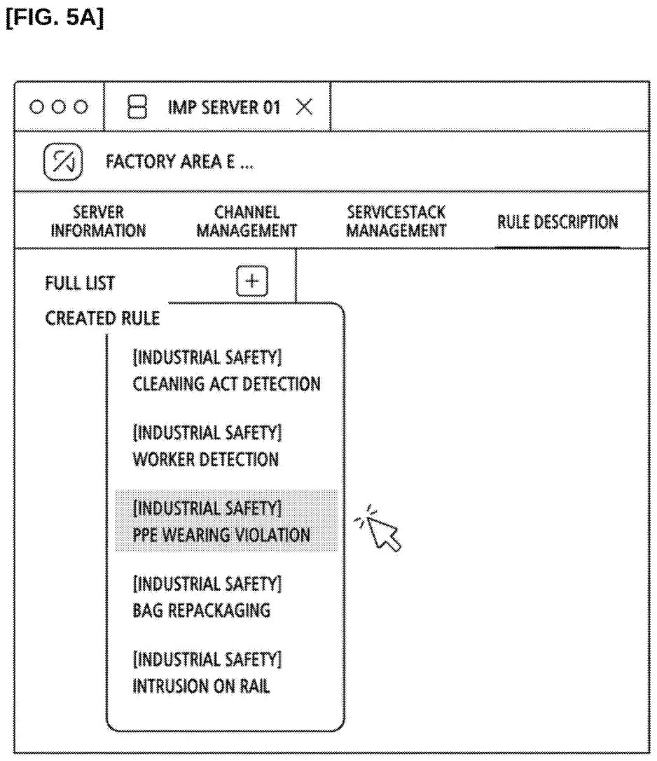

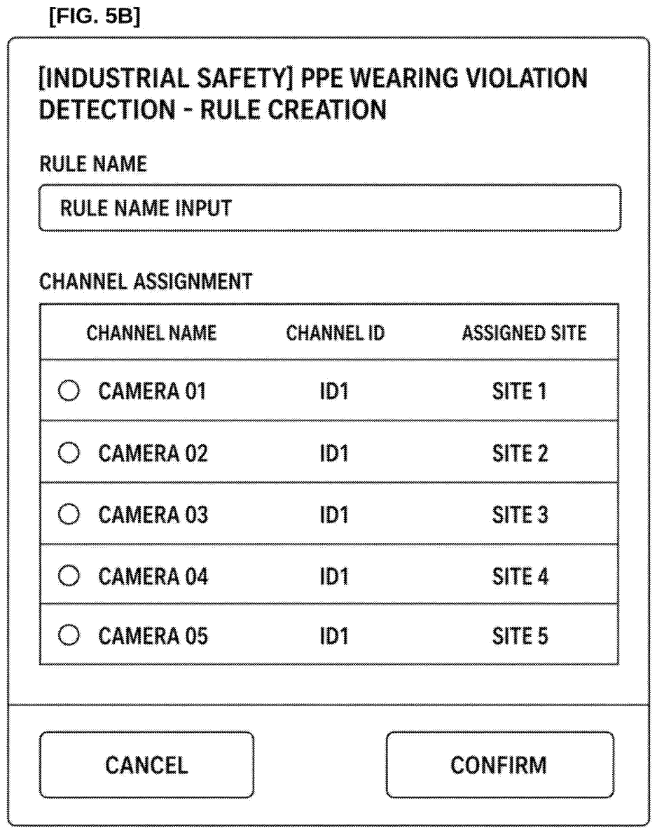

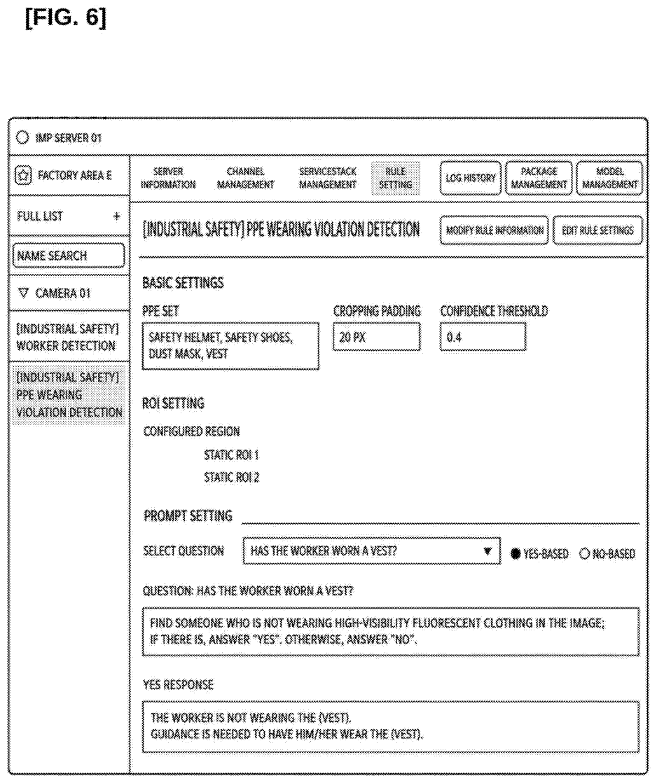

Hereinafter, with reference to FIGS. 5 and 6, an aspect of receiving the setting command for the target rule set from the client terminal 200 according to an embodiment of the present application will be described in more detail. FIG. 5 is a diagram illustrating an exemplary graphical user interface 210 of the client terminal 200 for explaining an aspect of receiving the setting command for the target rule set from the client terminal 200 according to an embodiment of the present application. FIG. 6 is a diagram illustrating an exemplary graphical user interface 210 of the client terminal 200 for explaining an aspect of receiving the setting command for the target rule set from the client terminal 200 according to an embodiment of the present application.

Referring to FIGS. 5 and 6, the user may, through the GUI 210 of the client terminal 200, select a target rule set, select a specific channel to which the corresponding rule set is to be applied, and input setting values for modifiable parameters belonging to the target rule set, thereby performing a series of processes for generating a target rule.

The screen of FIG. 5(a) shows an aspect in which the user selects the target rule set. The analysis server 1000 may be implemented to provide the user, through the client terminal 200, with a plurality of rule sets compatible with the inference engine 1600. For example, referring to FIG. 5(a), a plurality of rule sets predefined for each industry domain (e.g., [Industrial Safety] PPE Wearing Violation Detection, [Industrial Safety] Worker Detection, and the like) may be displayed.

The user may select a rule set suitable for the situation to be analyzed from such a list of rule sets. For example, in the case of detecting whether workers are wearing safety equipment at an industrial site, the user may select the “[Industrial Safety] PPE Wearing Violation Detection” rule set. The analysis server 1000 may receive an input for selecting the target rule set through the corresponding user selection. Each rule set defines the inference requirement for a structured vision inference task of an artificial intelligence model to be executed on the image processing pipeline 1500 prior to performing an unstructured vision inference task using the general-purpose inference model 1620 with respect to a specific industry domain (e.g., industrial safety, traffic control, public safety, and the like). For example, the “[Industrial Safety] PPE Wearing Violation Detection” rule set may include structured vision tasks such as an object detection (person detection) task and a classification (safety equipment wearing classification) task.

The screen of FIG. 5(b) shows an aspect of selecting a specific channel to which the selected target rule set is to be applied. The client terminal 200 may be implemented to provide the user with a list of at least one or more channels for selecting the specific channel to which the target rule set is to be applied.

As can be seen from “[Industrial Safety] PPE Wearing Violation Detection (A)-Rule Generation” of FIG. 5(b), the figure exemplarily shows a state in which the user has selected the “PPE Wearing Violation Detection” rule set. The user may select, from the list, a specific channel to which the target rule set is to be applied. For example, the user may select the channel corresponding to “Camera 01,” which captures the work area (site) of the industrial site. The analysis server 1000 may receive an input for selecting the specific channel to which the target rule set is to be applied through the corresponding user selection.

FIG. 6 illustrates a process in which the user configures modifiable parameters belonging to the selected target rule set. The analysis server 1000 may be implemented to provide the user, through the client terminal 200, with a screen for selecting setting values for the modifiable parameters belonging to the target rule set. The modifiable parameters include site-adaptive parameters, and may include a first parameter related to the image processing pipeline 1500 and a second parameter related to the general-purpose inference model 1620. The first parameter, as a parameter for analysis through the image processing pipeline 1500, may include parameters related to at least one of crop, which relates to the size of the area cut around a detected object, padding, which relates to the size of additional margins to be included from the object boundary during cropping, the confidence threshold, which relates to the minimum confidence score for considering a detection result of an artificial intelligence model to be valid, the region of interest in which the analysis is to be performed, the frame drop rate for adjusting the analysis load, the frame interval, which relates to the time interval between frames on which the analysis is to be performed, and/or the type of objects to be detected. The second parameter, as a parameter related to the query to be input to the general-purpose inference model 1620, may include parameters related to a query template to be used among a plurality of predefined query templates, and/or to a response form of the general-purpose inference model. The analysis server 1000 may receive an input for the setting values of the modifiable parameters through user input regarding the modifiable parameters.

As an example, in the case of the “[Industrial Safety] PPE Wearing Violation Detection” rule set shown in FIG. 6, the user may configure specific parameters as follows.

For example, in the basic settings, the user may set the PPE Set to “safety helmet, safety shoes, fluorescent clothing, dust mask, vest” to designate the types of protective equipment subject to detection. The image processing pipeline 1500 may be configured to execute an artificial intelligence model that detects or classifies whether such pieces of equipment are being worn. The user may set the cropping padding to “20 px” so that, when cropping a detected person object, a margin of 20 pixels is added from the bounding box. This is to include sufficient context in case the object boundary is not accurate. The user may also set the confidence threshold to “0.4” so that, among the results of classification of protective equipment by the artificial intelligence model, only those with a confidence of 40% or higher are considered valid detections, thereby removing low-confidence false detections.

In the region of interest (ROI) settings, the user may set a Static ROI and/or a Dynamic ROI to designate particularly hazardous areas or critical management areas within the work area. For example, the user may set an area where heavy equipment is operated as the ROI, so that whether PPE is being worn is detected only with respect to workers within the corresponding area.

In the prompt settings, the user may select “Is the worker wearing a vest?” as the question selection, thereby designating a query template that confirms whether a fluorescent vest is being worn. The user may set the query (prompt) to “Find someone who is not wearing a high-visibility fluorescent clothing in the image, if there is, answer ‘Yes’. Otherwise, answer ‘No’.” or modify the initial query template, thereby instructing the general-purpose inference model 1620 to find a person who is not wearing fluorescent clothing in the image and to answer “Yes” if any exists and “No” if none exists.

Through such configuration of modifiable parameters, an effect may be provided in which, while using the same “PPE Wearing Violation Detection” rule set, the analysis operation is optimized to fit the characteristics of the site (e.g., camera resolution, lighting conditions, the layout of the work area, the types of PPE to be managed, and the like).

Meanwhile, with respect to FIGS. 5 and 6, the description has been provided by way of example with respect to setting specific setting values for a specific rule set and specific parameters. However, this is merely an example for the convenience of explanation, and should not be construed as limiting.

The data processing logic 1610 of the analysis server 1000 according to an embodiment of the present application may perform an operation of generating a target rule based on a first input for selecting the target rule set, a second input for selecting the specific channel to which the target rule set is to be applied, and/or a third input regarding the setting values of the modifiable parameters, from the client terminal 200. The target rule may include a specified rule for generating the input data of the inference engine 1600 generated by applying the setting values for the modifiable parameters to the rule item belonging to the target rule set, with respect to the specific channel.

For example, by way of explanation using FIGS. 5 and 6 as illustrations, with respect to the specific channel “Camera 01,” a target rule for generating input data of the inference engine 1600 may be generated by applying setting values for the modifiable parameters of the rule items (PPE Set, cropping padding, confidence threshold, ROI, query template) belonging to the target rule set “[Industrial Safety] PPE Wearing Violation Detection” (PPE Set =“safety helmet, safety shoes, fluorescent clothing, dust mask, vest”; cropping padding=20 px; confidence threshold=0.4; ROI =Static ROI 1 and Static ROI 2; query=“Find someone who is not wearing a high-visibility fluorescent clothing in the image, if there is, answer ‘Yes’. Otherwise, answer ‘No’.”). The target rule generated in this way is utilized in the process of constructing the inference pipeline (IP), so that, with respect to a video sequence received from the “Camera 01” channel, the image processing pipeline 1500 may be implemented to perform analysis regarding PPE wearing violation detection according to the parameters (setting values) designated by the target rule.

According to an embodiment of the present invention, when generating the target rule, the analysis server 1000 may perform an operation of applying specific constraints in consideration of previously configured rules.

According to one aspect, when the data processing logic 1610 attempts to generate the target rule with respect to the specific channel, it may be implemented to check rule information previously assigned to the corresponding channel. Specifically, the data processing logic 1610 may obtain first rule set information and first rule information previously assigned to the specific channel. In addition, the data processing logic 1610 may receive a setting command for a candidate rule set and a candidate rule based on the first input through the third input obtained through the client terminal 200.

In this case, the data processing logic 1610 may compare the first rule set information with the candidate rule set to determine whether they are the same rule set. If the first rule set information and the candidate rule set are the same set, the data processing logic 1610 may restrict the candidate rule from being received as the target rule suitable for analysis with respect to the specific channel. This is to prevent different rules inheriting the same rule set from being identically assigned to one channel. On the other hand, if the first rule set information and the candidate rule set are different sets, the data processing logic 1610 may receive the candidate rule as the target rule suitable for analysis with respect to the specific channel. Through this, different rules inheriting different rule sets may be assigned to the same channel.

For example, in a state in which “Rule A” belonging to the “[Industrial Safety] PPE Wearing Violation Detection” rule set has already been assigned to the “Camera 01” channel, when the user attempts to assign “Rule B” belonging to the same “[Industrial Safety] PPE Wearing Violation Detection” rule set to “Camera 01,” the data processing logic 1610 may restrict it to prevent duplicate assignment of different rules belonging to the same rule set. However, when the user attempts to assign “Rule C” belonging to a different rule set “[Industrial Safety] Worker Detection“ to ”Camera 01,” the data processing logic 1610 may allow it so that various types of analyses may be simultaneously performed in one channel.

According to one aspect, when the data processing logic 1610 attempts to generate the target rule with respect to the specific channel, it may also be implemented to refer to rule information previously assigned to other channels. Specifically, the data processing logic 1610 may obtain second rule set information and second rule information previously assigned to a channel different from the specific channel. In addition, the data processing logic 1610 may receive a setting command for a candidate rule set and a candidate rule based on the first input through the third input obtained through the client terminal 200.

As constraints regarding other channels, even when the second rule set information and the candidate rule set are the same rule set, if the second rule information and the candidate rule are different from each other, the data processing logic 1610 may receive the candidate rule as the target rule suitable for analysis with respect to the specific channel. This is to allow different rules inheriting the same rule set to be assigned to different channels respectively.

For example, in a state in which “Rule A” belonging to the “[Industrial Safety] PPE Wearing Violation Detection” rule set has been assigned to the “Camera 02” channel, when the user attempts to assign “Rule B” belonging to the same “[Industria Safety] PPE Wearing Violation Detection” rule set to the “Camera 01” channel, the data processing logic 1610 may be implemented to allow it. Through this, different rules within the same rule set (e.g., rules with different parameter settings) may be distributed and applied to several channels, enabling analyses tailored to the characteristics of each channel.

Through such constraints, the event analysis system 10 of the present invention may maintain the consistency of rule configuration while supporting flexible composition, thereby providing an effect of preventing duplicate configurations or conflicts unintended by the user, and at the same time effectively handling various analysis requirements.

According to an embodiment of the present invention, the target rule generated according to the setting command for the target rule set obtained through the step S1300 may include various information necessary for the construction and execution of the inference pipeline (IP) in a structured form.

According to an embodiment, the target rule may include at least one of: a rule set identifier corresponding to the target rule set (e.g., a unique identifier of a rule set such as “[Industrial Safety] PPE Wearing Violation Detection”); a rule identifier corresponding to the target rule (e.g., a rule identifier for “PPE_Rule_Rule A,” a rule identifier for “PPE_Rule_Rule B”); first information regarding a parameter for configuring an output form of the image processing pipeline 1500 or a task of the image processing pipeline; second information regarding a query template associated with the rule identifier; third information for generating, as input data to be input to the general-purpose inference model 1620, a query based on the query template and the output of the image processing pipeline 1500; and/or fourth information regarding a logic associated with the rule identifier and for processing the output of the general-purpose inference model 1620.

Through the rule set identifier, it may be clearly identified to which rule set the target rule belongs, and through the rule identifier, rules with different parameter settings within the same rule set may be distinguished from each other.

The first information may include information regarding which structured vision task the image processing pipeline 1500 is to perform (e.g., object detection, classification, object tracking, pose estimation), which parameters are to be applied (e.g., the type of objects to be detected, the confidence threshold, the cropping padding), which region of interest (ROI) is to be analyzed, and the like.

The query template included in the second information defines the basic form of the query (or prompt) to be input to the general-purpose inference model 1620, and may include variables.

The third information may include logic that defines what value is to be substituted for the variable in the query template, and how the query is to be generated using which output (metadata, analysis data, metrics, and the like) of the image processing pipeline 1500 during query generation.

The fourth information may include parser information that defines how the output of the general-purpose inference model 1620 is to be parsed and interpreted. For example, information regarding a parser that converts a “Yes”/“No” response into a structured value, or a parser that extracts specific keywords from a free-form response, may be included in the fourth information.

Referring back to FIG. 4, in the step (S1300) of obtaining, from the image processing pipeline package, at least one image processing pipeline that satisfies the inference requirement of the target rule set, based on the setting command for the target rule set, the analysis server 1000 may be implemented to obtain, from the image processing pipeline package, at least one image processing pipeline 1500 that satisfies the inference requirement according to the target rule set and/or the target rule, based on the setting command for the target rule set obtained through the step S1200. Specifically, in the step S1300, an image processing pipeline 1500 capable of performing the structured vision tasks required by the target rule set is selected from the image processing pipeline package. As an example, if the target rule set requires an object detection task, an image processing pipeline 1500 capable of performing the corresponding tasks may be selected. As an example, if the target rule set requires a specific type of task, an image processing pipeline 1500 in which at least one artificial intelligence model capable of performing the specific task type can be optimally executed may be selected.

Meanwhile, with respect to the inference requirement, the description has been focused on the type of task. However, this is merely an example, and the inference requirement may further include the type of computer vision tasks such as object detection, segmentation, classification, object tracking, and/or pose estimation corresponding to a specific unstructured task within a specific industry domain, the type of pre-trained computer vision models, and/or limitations on the training data. Furthermore, the inference requirement according to an embodiment may further include requirements for a preset type of image processing pipeline or a combination of several preset types of image processing pipelines.

In the step (S1400) of constructing the inference pipeline based on the at least one image processing pipeline and the inference engine, the analysis server 1000 may construct the inference pipeline (IP) based on the at least one image processing pipeline 1500 and the inference engine 1600 that satisfy the inference requirement obtained through the step S1300.

According to an embodiment, the data processing logic 1610 of the analysis server 1000 may be implemented to configure the image processing pipeline 1500 based on the target rule belonging to the target rule set (the target rule including the rule item and the setting values of the modifiable parameter for each rule item). Specifically, the data processing logic 1610 may, based on the at least one image processing pipeline 1500 and the target rule, set the image processing pipeline 1500 to perform a structured vision analysis corresponding to the inference requirement corresponding to the target rule, by applying the target rule with respect to the specific channel.

Specifically, the data processing logic 1610 may transmit, to the image processing pipeline 1500, the inference requirement defined in the target rule (e.g., parameters such as the region of interest (ROI), the confidence threshold, the type of objects to be detected, crop, padding, frame drop rate, and/or frame interval), so that at least one artificial intelligence model to be executed in the image processing pipeline 1500 operates according to the corresponding requirement. For example, if the target rule is defined such that, with respect to the “Camera 01” channel, a person is to be detected with a confidence of 0.4 or higher within the region of interest of Static ROI 1 and whether a safety helmet is being worn is to be classified, the image processing pipeline 1500 may be configured to execute an object detection model and/or a classification model with respect to the corresponding ROI region, and to output only results having a confidence of 0.4 or higher.

According to an embodiment, the data processing logic 1610 of the analysis server 1000 may be implemented to generate, in response to setting values for the modifiable parameters being input through user input, structured data that defines the input data of the inference engine 1600. The data processing logic 1610 may configure the image processing pipeline 1500 to generate input data of the inference engine 1600 with respect to the specific channel using the structured data. Specifically, the image processing pipeline 1500 may be configured to output structured data including the rule set identifier, the rule identifier, the image, and/or the metadata and analysis data necessary for generating the input data of the inference engine 1600. Through this, when the data processing logic 1610 receives the output of the image processing pipeline 1500, it can generate, from the output of the image processing pipeline 1500, an appropriate query having a structured data form and transmit it to the inference model 1620.

In addition, the data processing logic 1610 may link the image processing pipeline 1500 and the inference model 1620 with each other using the identifier of the target rule set. The identifier of the target rule set serves as a criterion for determining which general-purpose inference model is to be mapped from among a plurality of general-purpose inference models, and the data processing logic 1610 enables mapping and linking with the correct inference model 1620 to which the query is to be input, using the rule set identifier included in the output of the image processing pipeline 1500.

Through this, the inference engine 1600 of the inference pipeline (IP) and the image processing pipeline 1500 are linked with each other, whereby the inference pipeline (IP) is constructed.

The constructed inference pipeline may receive a video sequence from the data source server 100, perform a structured vision task through the image processing pipeline 1500, and perform an unstructured vision task through the inference engine 1600, thereby ultimately enabling event detection. Through such a method of construction, an effect may be provided in which an inference pipeline (IP) capable of adapting to various industry domains may be quickly constructed simply by changing only the target rule set.

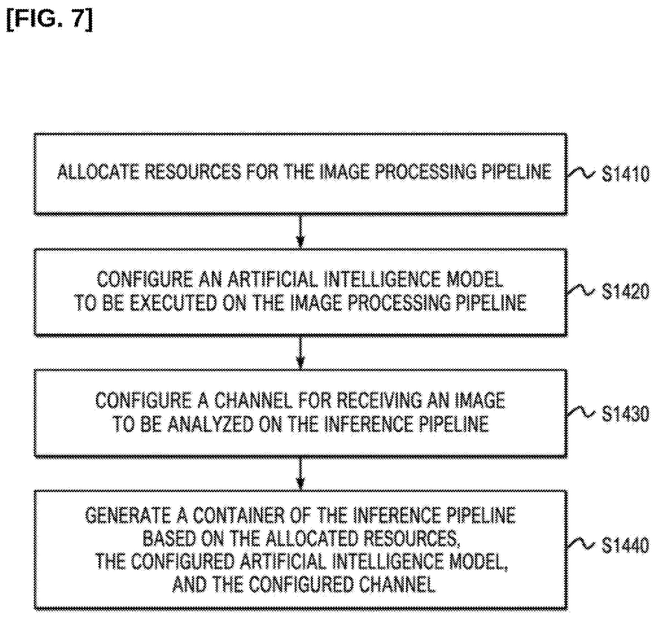

Hereinafter, with reference to FIGS. 7 to 9, an aspect of constructing the inference pipeline (IP) will be described in more detail.

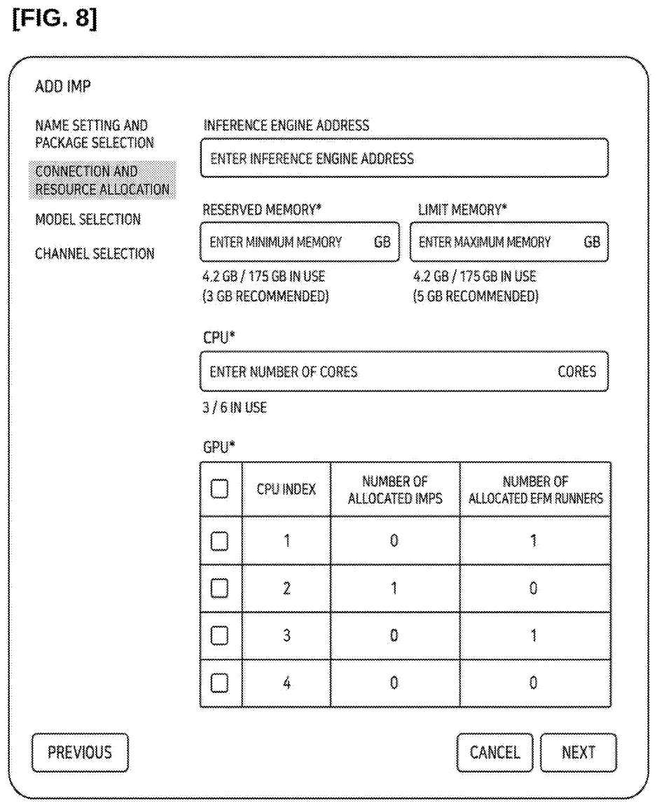

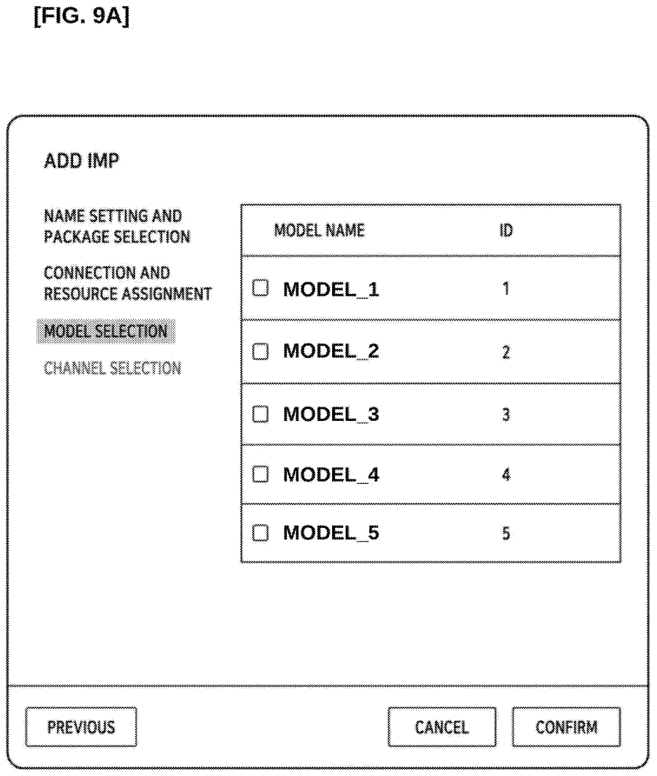

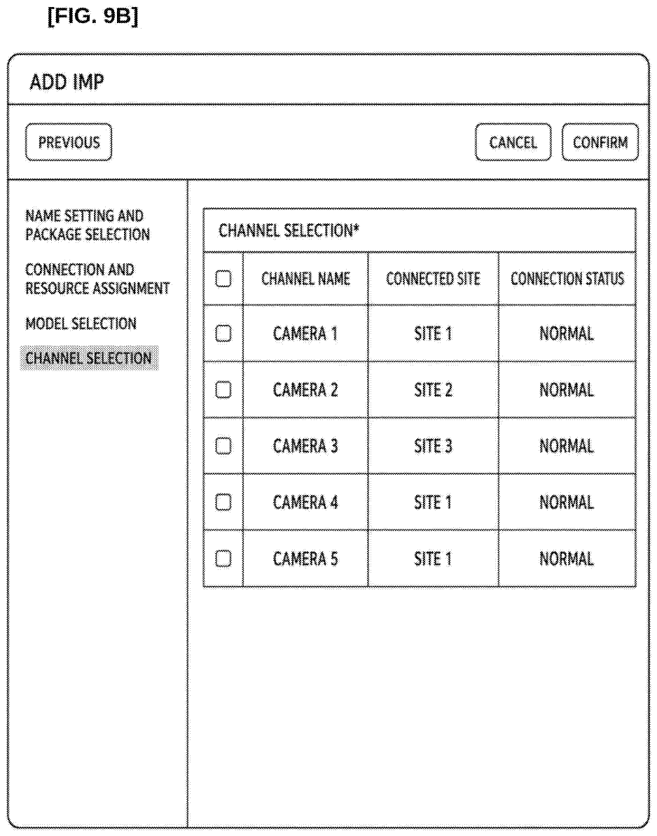

FIG. 7 is a specific flowchart of the step (S1400) of constructing the inference pipeline according to an embodiment of the present application. FIG. 8 is a diagram illustrating an exemplary graphical user interface 210 of the client terminal 200 for explaining an aspect of receiving a setting command for allocating a resource for the image processing pipeline 1500 from the client terminal 200 according to an embodiment of the present application. FIG. 9 is a diagram illustrating an exemplary graphical user interface 210 of the client terminal 200 for explaining an aspect of receiving a setting command for selecting a channel to be linked with an artificial intelligence model that is to be executed on the image processing pipeline 1500 from the client terminal 200 according to an embodiment of the present application.

The step (S1400) of constructing the inference pipeline according to an embodiment of the present application may further include: a step (S1410) of allocating a resource for the image processing pipeline; a step (S1420) of configuring an artificial intelligence model to be executed on the image processing pipeline; a step (S1430) of configuring a channel for receiving an image to be analyzed on the inference pipeline; and/or a step (S1440) of generating a container of the inference pipeline based on the allocated resource, the configured artificial intelligence model, and the configured channel.

Referring to FIG. 8, with respect to the step S1410, the user may, through the GUI 210 of the client terminal 200, configure hardware resources to be allocated to an instance of the at least one image processing pipeline 1500 obtained through the step S1300. The GUI 210 may visually display the status of the server hardware resources (CPU, GPU, memory), and the user may input, in the reserved memory and limit memory fields, a memory capacity to be used by the instance of the image processing pipeline 1500. For example, the screen may display the current memory usage status and recommended values, such as “4.2 GB/175 GB in use (3 GB recommended).” The memory allocation is intended to ensure that the process using the image processing pipeline 1500 operates smoothly within the allocated memory resources without interfering with other processes. If resources are not allocated in advance, when one image processing pipeline abnormally consumes excessive memory, it may affect the processes of other image processing pipelines or the inference engine.

In addition, the user may input, in the CPU field, the number of CPU cores to be used by the instance of the image processing pipeline 1500.

In addition, the user selects, in the GPU section, a GPU to be allocated to the instance of the image processing pipeline 1500. As an example, the screen of FIG. 8 may display available GPU indexes and the number of image processing pipelines and the number of inference model runners currently allocated to each GPU. For example, GPU 1 may be displayed as “Number of allocated image processing pipelines (IMPs): 0, Number of allocated inference model (EFM) runners: 1,” so that the user may grasp the resource distribution status and select an appropriate GPU.

Referring to the screen of FIG. 9(a), with respect to the step S1420, the user may select an artificial intelligence model to be executed on the image processing pipeline 1500. The GUI 210 may be implemented to display a list of artificial intelligence models that have been uploaded in advance. For example, the screen may display the model name and the ID of each model in a table form.

In this case, the selectable artificial intelligence models may be models selected, from a model pool including a plurality of models optimized for different hardware, as models whose performance has been verified for the hardware specification information of the server on which the analysis is to be performed. The selectable artificial intelligence models may be models that have been quantized to fit the computational capability and inference requirements of specific hardware (GPU). For example, the list may include an artificial intelligence model (e.g., a computer vision model) suitable for the inference requirement of detecting an object called “person,” for which performance has been verified for the hardware specification information of the server on which the analysis is to be performed; a general-purpose inference model (e.g., a vision-language model) for detecting “human behavior”; an optimized model for providing fast inference speed and precision with low power on edge devices; and a model providing high accuracy on a high-performance server. The user may select at least one or more models suitable for the analysis to be executed on the image processing pipeline 1500 from among the selectable artificial intelligence models.

Referring to the screen of FIG. 9(b), with respect to the step S1430, the user may select an image channel to be processed by the image processing pipeline 1500. The GUI 210 may display a list of pre-registered channels, and the screen may display, in a table form, the channel name (e.g., Camera 001, Camera 002), the connected site for each channel (e.g., Site 001, Site 002), and the connection status (e.g., normal). The user may select one or more channels to be processed by the image processing pipeline 1500 through checkboxes.

When the user performs settings regarding resource allocation, model setting, and/or channel setting, the connection agent 1400 of the analysis server 1000 may receive such setting information.

In addition, the connection agent 1400 of the analysis server 1000 may be implemented to automatically generate a container execution configuration based on the at least one image processing pipeline 1500 obtained in the step S1300, and the allocated resource, the artificial intelligence model, and/or the configured channel. In the case of the CPU, sequential indexes may be automatically allocated based on the number of cores input by the user, and the GPU and memory may be applied as container runtime options according to the designated values. Thereafter, the selected artificial intelligence model is loaded inside the container, the connected channel input stream is bound to the image processing pipeline 1500, and an instance of the image processing pipeline 1500 of the inference pipeline (IP) may be executed.

According to an embodiment of the present invention, similarly to the image processing pipeline 1500, the inference engine 1600 may also be generated and constructed in a container-based manner based on user settings.

Specifically, the user may, through the GUI 210 of the client terminal 200, allocate a GPU and the general-purpose inference model 1620 to be used by the inference engine 1600. Likewise, a list of selectable general-purpose inference models may be displayed through the GUI, and the selectable general-purpose inference models may be models selected, from a model pool including a plurality of inference models optimized for different hardware, as models whose performance has been verified in consideration of compatibility with the image processing pipeline and the hardware specification information of the server on which the analysis is to be performed. The connection agent 1400 may be implemented to automatically generate a container execution configuration for the inference engine 1600 based on the settings input by the user. The selected general-purpose inference model 1620 is loaded inside the container and bound to the inference engine 1600, and once the container is started, the general-purpose inference model 1620 of the inference engine 1600 is executed together with the data processing logic 1610, so that the inference pipeline (IP) may be constructed to perform unstructured vision task inference.

Through such a process, the image processing pipeline package, the artificial intelligence model to be executed on the image processing pipeline 1500, and/or the general-purpose inference model 1620 may be combined in a form optimized for the hardware specification of the server on which the analysis is to be performed, whereby the inference pipeline (IP) may be constructed. By having the image processing pipeline 1500 and the inference engine 1600 generated and managed as independent containers, an effect of improving the scalability and flexibility of the system may be provided.

Meanwhile, with respect to FIGS. 7 to 9, the description has been provided assuming that resources for instances of the image processing pipeline 1500 and the inference engine 1600 are allocated through user input. However, this is merely an example, and the resource allocation may also be implemented to be automatically distributed in consideration of the selected package, the characteristics of the model (size, complexity, number of parameters, and the like), the characteristics of the data to be processed (number of channels, resolution, and the like), and/or the hardware specification of the server.

Meanwhile, with respect to FIGS. 7 to 9, the description has been provided assuming that the artificial intelligence model and/or the general-purpose inference model 1620 to be executed on the image processing pipeline 1500 are finally determined through user input. However, this is merely an example, and they may also be implemented to be automatically determined based on performance taking into consideration the hardware specification information of the server on which the analysis is to be performed.

Meanwhile, while the independent container structure of the image processing pipeline 1500 and the inference engine 1600 improves the scalability and flexibility of the system, it simultaneously requires a mechanism for mapping such that the query according to the output of the image processing pipeline 1500 is input to an appropriate inference model 1620.

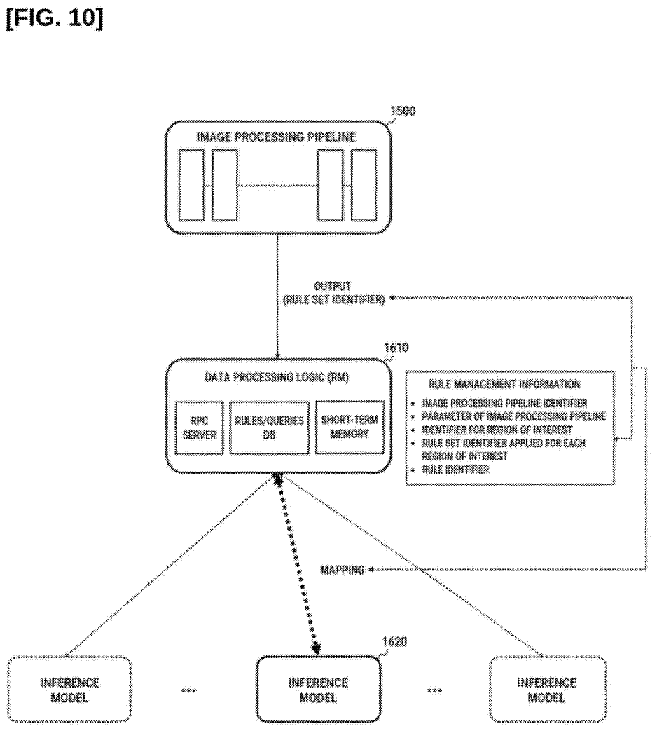

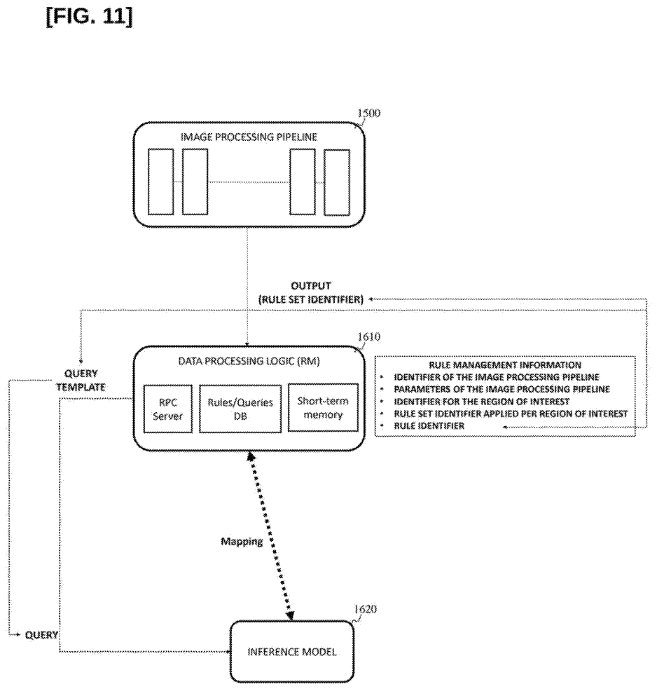

Hereinafter, with reference to FIGS. 10 and 11, an aspect of mapping the image processing pipeline 1500 and the general-purpose inference model 1620 to each other according to an embodiment of the present application will be described in more detail. FIG. 11 is a diagram for explaining an aspect of constructing the inference pipeline (IP) and an aspect of performing inference using the inference pipeline (IP) according to an embodiment of the present application.

FIG. 10 is a diagram for explaining an aspect of constructing the inference pipeline (IP) according to an embodiment of the present application. Specifically, FIG. 10 is a diagram for explaining an aspect in which the data processing logic 1610 maps the image processing pipeline 1500 and the general-purpose inference model 1620 based on the rule set identifier to construct the inference pipeline (IP).

The data processing logic 1610 of the analysis server 1000 according to an embodiment of the present application may perform an operation of mapping between the image processing pipeline 1500 and the general-purpose inference model 1620 based on the rule set identifier. The image processing pipeline 1500 may be defined to include, in its output, the rule set identifier applied in analyzing the video sequence when processing the video sequence. The data processing logic 1610 may determine which general-purpose inference model 1620 is to be used, based on the rule set identifier included in the output of the image processing pipeline 1500.

Meanwhile, in accordance with the construction of the inference pipeline (IP), the data processing logic 1610 may perform an operation of storing, in the memory of the data processing logic 1610, rule management information including at least one of the identifier of the image processing pipeline 1500 included in the constructed inference pipeline (IP), parameters for executing the image processing pipeline 1500 (and/or the artificial intelligence model to be executed on the image processing pipeline 1500), an identifier of a region of interest configured to be detected through the image processing pipeline 1500, a rule set identifier corresponding to the target rule set applied for each region of interest, and a rule identifier corresponding to the target rule belonging to the target rule set. Meanwhile, the rule management information may be stored and managed on a per-channel basis. Such rule management information may be referenced during the construction or execution of the inference pipeline (IP), and may be utilized in matching the output of the image processing pipeline 1500 with an appropriate general-purpose inference model 1620.

Specifically, the data processing logic 1610 may identify the rule set identifier included in the output of the image processing pipeline 1500. The image processing pipeline 1500 may be configured to include, in its output, a rule set identifier indicating by which rule set the data has been processed while performing the first processing.

In this case, the data processing logic 1610 may be implemented to map the general-purpose inference model 1620 of the inference pipeline (IP) that is to perform unstructured vision task inference based on the identified rule set identifier, with reference to the rule set identifier applied for each channel and for each region of interest in the rule management information.

In addition, referring to FIG. 11, the data processing logic 1610 may be implemented to input the input data (the query and the image) generated by applying the target rule into the mapped general-purpose inference model 1620. Specifically, the data processing logic 1610 may, with reference to the rule identifier of the rule management information, obtain a query template associated with the rule identifier, apply the target rule (e.g., the third information included in the constraint information described later) to the output of the image processing pipeline 1500 to compute the variables included in the query template, generate the input data, and transmit the generated input data to the mapped general-purpose inference model 1620.

For example, when an output including the rule set identifier for “[Industrial Safety] PPE Wearing Violation Detection” is received, the data processing logic 1610 may map a general-purpose inference model 1620 whose performance has been verified for the rule set corresponding to the rule set identifier, generate a query for confirming whether PPE is being worn, and input the query into the corresponding general-purpose inference model 1620. Meanwhile, in the case of “Rule A of [Industrial Safety] PPE Wearing Violation Detection,” the data processing logic 1610 may obtain a query template associated with Rule A, apply the query generation logic (third information) included in Rule A to the output of the image processing pipeline 1500 to compute the variables included in the query template, generate the input data, and transmit the generated input data to the mapped general-purpose inference model 1620.

Through such a rule set identifier-based mapping mechanism, the system 10 of the present invention may automatically map a general-purpose inference model 1620 optimized for the characteristics of each rule set and use it for inference, while maintaining the independent instance structure of the image processing pipeline 1500 and the inference engine 1600. In addition, even in an environment in which a plurality of inference models are simultaneously executed, by ensuring that each piece of data is delivered to the correct inference model, an effect of maintaining the stability and accuracy of the system may be provided.

According to an embodiment of the present invention, the inference pipeline (IP) may be constructed as a pipeline group including a plurality of image processing pipelines 1500 according to the selected target rule set. Specifically, when the analysis server 1000 receives a setting command for a first target rule set, the inference pipeline (IP) may be constructed as a first pipeline group composed of at least one of a first image processing pipeline and a second image processing pipeline. On the other hand, when the analysis server 1000 receives a setting command for a second target rule set, the inference pipeline (IP) may be constructed as a second pipeline group composed of at least one of the second image processing pipeline and a third image processing pipeline. In other words, inference pipelines (IPs) constructed according to different rule sets may be constructed to include a common image processing pipeline (e.g., the second image processing pipeline), or may be constructed to include unique image processing pipelines (e.g., the first image processing pipeline of the first pipeline group, the third image processing pipeline of the second pipeline group) depending on the characteristics of each rule set.

Meanwhile, when the inference pipeline (IP) is constructed through FIGS. 4 to 11, the inference pipeline (IP) may perform analysis on image-based events.

The constructed inference pipeline (IP) may be composed of the image processing pipeline 1500 and the inference engine 1600. In the image processing pipeline 1500, a computer vision-based model that performs structured vision tasks is executed, and in the inference engine 1600, the general-purpose inference model 1620 that performs unstructured vision task inference may be executed. The image processing pipeline 1500 may be configured to process the video stream input from the data source server 100 to generate a data set including object-based metadata and analysis data, and to transmit the data set to the industry domain-adaptive data processing logic 1610. In this case, the data set may be output in a structured form by the target rule generated during the construction of the inference pipeline (IP).

The data processing logic 1610 may be configured to select the query template to be applied to the corresponding data with reference to the rule identifier included in the data set received from the image processing pipeline 1500, and to generate the query to be input to the general-purpose inference model 1620 by computing the variables of the query template using the metadata of the data set. Meanwhile, the general-purpose inference model 1620 to which the query is to be input may be a model mapped through the rule set identifier included in the data set.

The general-purpose inference model 1620 may be configured to generate an output in natural language form based on the generated query, and the data processing logic 1610 may be configured to convert the output of the general-purpose inference model 1620 into structured data through a parser associated with the rule identifier of the target rule. Furthermore, the data processing logic 1610 may generate event information based on the analysis result through the image processing pipeline 1500 and the parsed result of the output of the general-purpose inference model 1620, and the event information may be provided to the user through the client terminal 200, or may be stored in the short-term memory of the data processing logic 1610.

Hereinafter, with reference to FIGS. 12 to 18, an aspect of event analysis according to an embodiment of the present application will be described in more detail. According to an embodiment, FIGS. 12 to 18 will be described in detail with respect to an aspect of analyzing an event using the inference pipeline constructed by the aspect of constructing the inference pipeline described with reference to FIGS. 4 to 11. Meanwhile, in describing the method for analyzing an event using the inference pipeline, some embodiments overlapping with the contents previously described with reference to FIGS. 1 to 11 may be omitted. However, this is merely for the convenience of explanation, and should not be construed as limiting.

FIG. 12 is a diagram for explaining an aspect of analyzing an event using the constructed inference pipeline according to an embodiment of the present application.

As shown in FIG. 12, the inference pipeline (IP, analysis pipeline) of the present invention may be broadly composed of the image processing pipeline 1500, the data processing logic 1610, and/or a second model 1620 as the general-purpose inference model.

The image processing pipeline 1500 may perform an operation of receiving a video sequence from the data source server 100 and performing primary analysis. A first model may be executed on the image processing pipeline 1500. The first model is a computer vision-based artificial intelligence model, and may perform object detection-based structured vision tasks such as object detection, segmentation, classification, object tracking, and/or pose estimation. The processing result of the first model may be output in the form of a first data set structured by the target rule generated during pipeline construction, and the first data set may be transmitted to the data processing logic 1610 of the inference engine 1600.

The data processing logic 1610 may perform operations of generating a query to be input to the second model 1620 based on the first data set, and post-processing the output of the second model 1620 to ultimately determine an event present in the image. The data processing logic 1610 may include sub-components such as an RPC Server, a Rules/Queries DB, and/or a Short-term memory. The RPC Server provides a communication interface with external devices including the client terminal 200, the Rules/Queries DB stores and manages various rules and query templates, and the Short-term memory is a sub-component that stores event information for preserving the context between events.

The second model 1620 is a vision-language model (VLM), and is configured to generate an output in text form based on the generated query. In particular, the second model 1620 performs context-aware unstructured vision task inference, and is capable of understanding and making determinations regarding complex situations that have not been predefined.

The data processing logic 1610 may post-process the output of the second model 1620 to determine an event present in the image and to generate event information. Specifically, the data processing logic 1610 may generate the event information by combining the result of processing through the image processing pipeline 1500 and the result of post-processing of the data processing logic 1610. The event information may include a video (or a cropped image) used for the analysis, an embedding or a metric according to the result of processing through the image processing pipeline 1500, the type of detected event, and/or constraint information.

The image processing pipeline 1500, the data processing logic 1610, and the second model 1620 included in the inference pipeline (IP) may be organically linked centering on the constraint information to perform the analysis. The constraint information is information corresponding to the target rule generated by the user through the client terminal 200 as previously described in connection with FIGS. 4 to 11, and may include at least one of the rule set identifier, the rule identifier, the parameters of the first model, the query template, the query generation information, and/or the parser information. The constraint information defines the analysis operation of the entire inference pipeline (IP), and may be referenced at each processing step.

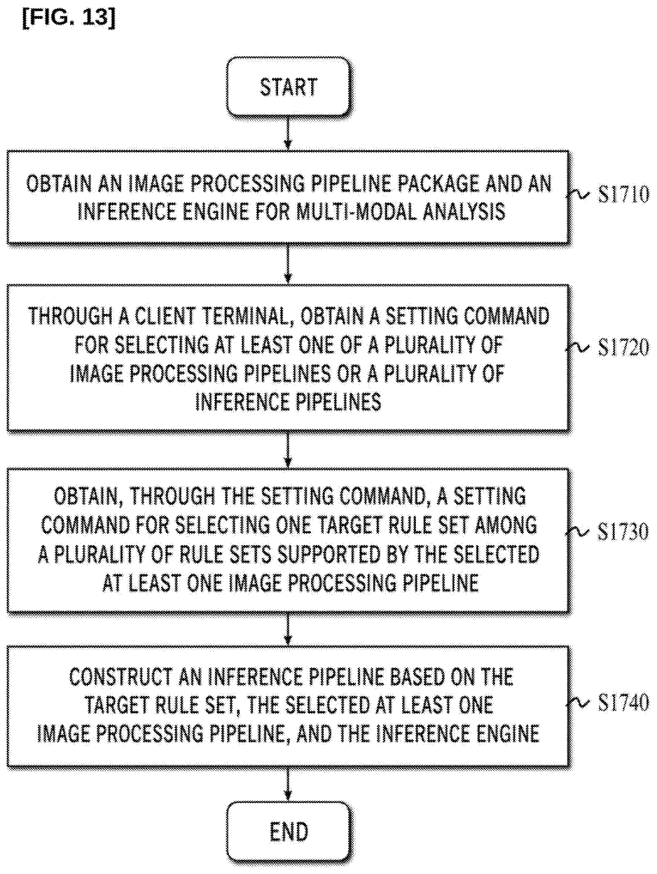

FIG. 13 is a flowchart illustrating a method for constructing the inference pipeline according to another embodiment of the present application. While the previously described embodiment of FIG. 4 represents a goal-oriented approach in which an analysis purpose (rule set) is determined first and the system maps a pipeline suitable therefor, the embodiment of FIG. 13 represents a resource-or task-centered method of construction in which an engineer first determines the structure of the pipeline in consideration of available resources or the characteristics of a task to be performed, and then specifies it in detail.

Referring to FIG. 13, the method for constructing the inference pipeline according to an embodiment of the present application may include: a step (S1710) of obtaining an image processing pipeline package and an inference engine for multi-modal analysis; a step (S1720) of obtaining, through the client terminal, a setting command for selecting at least one of a plurality of image processing pipelines included in the image processing pipeline package; a step (S1730) of obtaining a setting command for selecting any one of at least one rule set supported by the at least one image processing pipeline selected, as a target rule set; and a step (S1740) of constructing the inference pipeline based on the target rule set, the at least one image processing pipeline selected, and the inference engine.

In the step (S1710) of obtaining the image processing pipeline package and the inference engine for multi-modal analysis, the analysis server 1000 may obtain or prepare a list of basic inference pipelines selectable by the user. Here, a basic inference pipeline refers to a pipeline that has a structure in which an image processing pipeline and an inference engine including a general-purpose inference model and a data processing logic are combined, but in which specific analysis parameters or queries (prompts) have not been configured. The list may include a case in which only the image processing pipeline is included alone, a case in which the basic inference pipeline in a complete form combining the image processing pipeline and the inference engine is included, or a case in which these are mixed.

In the step (S1720) of obtaining, through the client terminal, a setting command for selecting at least one of the plurality of image processing pipelines included in the image processing pipeline package, the user may select one of the basic inference pipelines provided through the client terminal 200. In this case, the user may select, from among the list of basic inference pipelines, a basic inference pipeline having a structure optimized for the hardware specifications of the server on which the analysis is to be performed (e.g., NVIDIA GPU, Qualcomm NPU, and the like) or for a task that the engineer specifically intends to perform (e.g., highway traffic control, factory safety management, and the like). For example, the engineer may begin a system design that prioritizes hardware resource constraints by first selecting, from among the list of basic inference pipelines, a lightweight basic inference pipeline that can run on a specific edge device.

In the step (S1730) of obtaining the setting command for selecting any one rule set, as the target rule set, from among at least one rule set supported by the at least one image processing pipeline selected through the setting command, the analysis server 1000 may, in consideration of the technical characteristics or constraints of the basic inference pipeline selected through the step S1720, filter (deactivate) rule sets that are difficult to operate normally on the corresponding pipeline, and activate rule sets that can operate normally on the corresponding pipeline, and provide them to the user. In an embodiment, the rule sets supported by one basic inference pipeline may include rule sets of different industry domains. The user may select a target rule set that meets the analysis purpose (e.g., safety helmet non-wearing detection) from among the activated list of rule sets. For example, when the user has selected a “vehicle analysis-dedicated pipeline” in the previous step, the analysis server 1000 may deactivate (filter) rule sets such as “safety helmet non-wearing detection” or “worker collapse detection,” and activate only rule sets related to vehicle objects such as “illegal parking detection,” “lane departure detection,” and “vehicle fire detection,” and provide them through the client terminal 200. Accordingly, the user may select, through the client terminal 200, a target rule set that meets the analysis purpose from among the list of rule sets. In an embodiment, the basic inference pipeline may be defined by functions included in the basic inference pipeline, without being limited to a specific industry domain. For example, the basic inference pipeline may include a first basic inference pipeline that detects a bounding box (BBOX) of a specific object within a region of interest (ROI), and a second basic inference pipeline that triggers generation of a specific query when a bounding box of a person is detected in an image. The rule sets supported by such basic inference pipelines may include rule sets of different industry domains. When the user has selected the first basic inference pipeline among the first basic inference pipeline and the second basic inference pipeline in the previous step, lists of rule sets of various industry domains supported by the first basic inference pipeline may be provided to the user through the client terminal 200. Accordingly, the user may select, through the client terminal 200, a target rule set that meets the analysis purpose (e.g., a specific industry domain) from among the list of rule sets.

In the step (S1740) of constructing the inference pipeline based on the target rule set, the at least one image processing pipeline selected, and the inference engine, the analysis server 1000 may construct a final inference pipeline by specifying the basic inference pipeline based on the target rule set selected through the step S1730. In this process, the parameters or queries defined in the target rule set may be applied to the basic inference pipeline.

Specifically, in the step S1740, the analysis server 1000 may automatically apply, in the form of a preset, the optimized parameters defined in the target rule set (e.g., a threshold, region of interest setting, and the like) to the basic inference pipeline, or may provide guidelines for parameter configuration to encourage the user to directly configure the parameters with reference thereto. As an example, when the “fire detection” rule set is selected as the target rule set, the confidence threshold may be preset to “0.85” and automatically applied to the basic inference pipeline in order to reduce false alarms. On the other hand, when the “intrusion detection” rule set, which is sensitive to the camera installation angle, is selected as the target rule set, the analysis server 1000 may display, on the UI, a guideline such as “If the camera is installed at a height of 3 m or more, set the threshold to 0.6 or higher” to encourage the user to make direct configurations.

In addition, in the step S1740, in configuring the query (prompt) to be input to the general-purpose inference model, the analysis server 1000 may provide the user with a plurality of prompt options associated with the target rule set. The user may, through the client terminal, generate a rule by selecting one of the plurality of provided prompt options as is, modifying the selected prompt to fit the on-site situation, or directly writing a new prompt according to provided writing guidelines. By injecting the setting values thus finalized into the basic inference pipeline, an executable inference pipeline specialized for a specific industry domain is finally constructed.

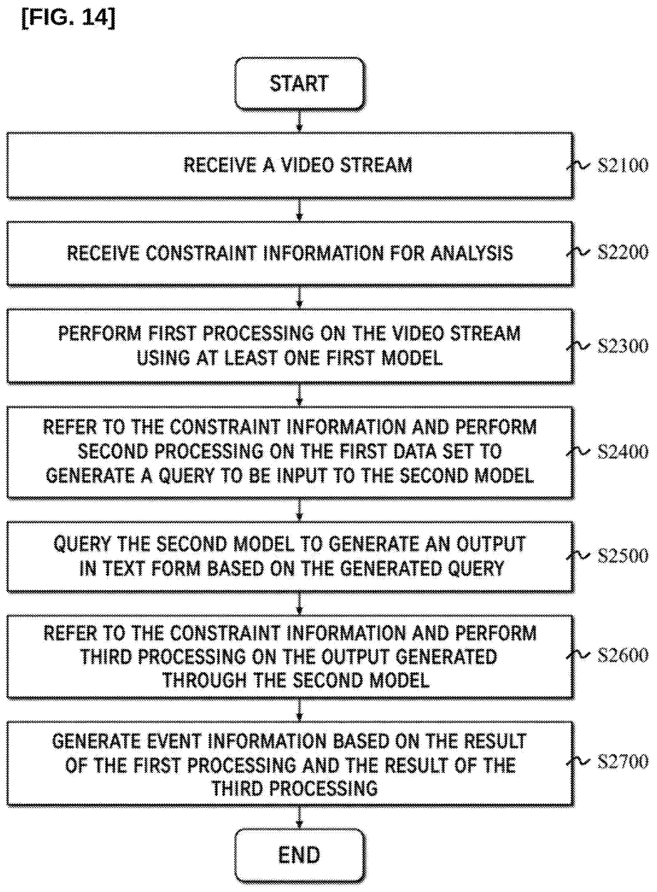

FIG. 14 is a flowchart illustrating a method for analyzing an event using the constructed inference pipeline (IP) according to an embodiment of the present application. Specifically, FIG. 14 is a flowchart showing the flow of an event analysis aspect performed by the inference pipeline (IP) of the event analysis system 10 illustrated in FIG. 12.

The method for analyzing an event according to an embodiment of the present application may include: a step (S2100) of receiving a video stream; a step (S2200) of receiving constraint information for analysis; a step (S2300) of performing first processing on the video stream using at least one first model; a step (S2400) of generating a query to be input to a second model by performing second processing on a first data set with reference to the constraint information; a step (S2500) of querying the second model, which generates an output in text form, based on the generated query; a step (S2600) of performing third processing on the output generated through the second model with reference to the constraint information; and/or a step (S2700) of generating event information based on a result of the first processing and a result of the third processing. Each step may be performed with reference to the constraint information, through which analysis specialized for a specific industry domain may be possible according to the target rule configured by the user through the client terminal 200. The first model may be configured to process an image (the first processing) based on parameters related to the first model included in the constraint information, and the data processing logic 1610 may be configured to generate an appropriate query to be input to the second model 1620 using the query template and the query generation information included in the constraint information. In addition, the data processing logic 1610 may convert the output of the second model 1620 into a structured form using the parser information included in the constraint information.

In the step (S2100) of receiving the video stream, the image processing pipeline 1500 of the inference pipeline (IP) may receive a video stream from the data source server 100. The video stream may be in any appropriate form, including a real-time RTSP stream, a video file, and/or an image sequence. For example, in the case of monitoring a work site of a factory, a real-time video stream from a CCTV camera may be received, and in the case of analyzing a traffic situation, an image from a camera installed on a road may be received.

In the step (S2200) of receiving the constraint information, the inference pipeline (IP) may receive constraint information for analysis. The constraint information may be information corresponding to the target rule generated through the aspect of constructing the inference pipeline (IP) previously described in FIGS. 4 to 11. That is, when the target rule set is selected, a channel is allocated, and the modifiable parameters are configured through the client terminal 200, and a target rule is generated, the target rule may be transmitted to the inference pipeline (IP) in the form of constraint information, thereby controlling the execution operation of the inference pipeline.

The constraint information may include at least one of: a constraint identifier; first information defining the operation of the first model executed in the image processing pipeline 1500; second information regarding a query template; third information regarding a query generation logic; and/or fourth information regarding a parser for processing the output of the second model (VLM).

The constraint identifier may include a rule set identifier and a rule identifier. The rule set identifier is for distinguishing rule sets related to a specific industry domain, and the rule identifier is for identifying individual rules within the corresponding rule set.

The first information may be information regarding inference requirements including parameters for configuring an output form of the image processing pipeline 1500 or information regarding a task of the image processing pipeline 1500. As specific examples, the first information may include parameters related to the type of objects to be detected, the confidence threshold, region of interest (ROI) information, crop parameters, padding parameters, the frame drop rate, and/or the frame interval.

The second information is information regarding a query template associated with the constraint identifier (rule identifier). The query template defines the basic structure of a query to be queried to the second model 1620 in the form of a vision-language model (VLM), and may include variables. Here, the query template may be a query template configured during the construction process of the inference pipeline (IP) as a query template whose performance has been verified in advance with respect to the rule set corresponding to the rule set identifier of the constraint identifier. For example, it may be in a form such as “In the image, there is a person at position {bbox_coordinates}. Is this person wearing a safety helmet?”, where {bbox_coordinates} is a variable. According to an embodiment, the query may be in the form of a prompt.

The third information may be information defining a logic for generating the query to be input to the second model 1620 based on the query template and the first data set, which is the output of the image processing pipeline 1500. The third information defines how the variables included in the query template are to be calculated and substituted. For example, the third information may include a logic for extracting the variable {bbox_coordinates} of a query template such as “In the image, there is a person at position {bbox_coordinates}. Is this person wearing a safety helmet?” based on the metadata included in the first data set, and generating the query.

The fourth information may be information defining the type and/or the logic of a parser for processing the output of the second model 1620 in the form of a vision-language model (VLM), associated with the constraint identifier (rule identifier). Since the output of the vision-language model is in the form of natural language text, the output of the second model 1620 may be processed into a refined form through a parsing logic for converting it into structured data.

In the step (S2300) of performing the first processing on the video stream using at least one first model, the image processing pipeline 1500 of the inference pipeline (IP) may perform the first processing on the video stream using at least one first model. The first model performs the first processing with reference to the constraint information received in step S2200, and as a result thereof, may be configured to output the first data set. Specifically, the first model may be configured to output the result of the first processing as the first data set in a structured form, with reference to the first information of the constraint information.

The first model is a computer vision-based artificial intelligence model and may perform structured vision tasks. A structured vision task means a visual analysis task with predefined and clear objectives, and may include a task related to at least one of object detection, segmentation, classification, object tracking, and pose estimation.

The first model may be configured to operate according to parameters defined in the first information of the constraint information. For example, when the confidence threshold is set to 0.7 in the first information, the first model may be configured to output only detection results having a confidence of 0.7 or higher.

The first data set generated as a result of the first processing may include a channel identifier on which the image was captured, a constraint identifier, object-based metadata, analysis data through the first model, and/or an image (or cropped image) used for the analysis.

The constraint identifier indicates by which rule set and which rule the corresponding data has been generated, and the rule identifier may be utilized in selecting an appropriate query template and parser in subsequent steps.

The object-based metadata is raw data output by the first model, and may include an object ID, an object class, bounding box coordinates, a confidence score, a segmentation mask, keypoint coordinates and confidence, and/or a tracking identifier.

The analysis data through the first model means industry data for a specific domain extracted by processing the object-based metadata. For example, in the case of monitoring a road situation, the analysis data may include data such as traffic volume, average vehicle speed, and/or the average distance between pedestrians and vehicles, computed from the object-based metadata. For example, in the case of monitoring the inside of an industrial site, the analysis data may include data such as whether each object is wearing work clothes and a safety helmet.

The image used for the analysis may be the original image used for the first processing or an image cropped with respect to a region of interest.

As a specific example, when the “Worker Safety Equipment Detection” rule set is applied to a channel monitoring the inside of an industrial site, the first model may be implemented to detect a person in the image, classify whether a safety helmet and work clothes are being worn with respect to the detected person area, generate the first data set, and transmit the first data set to the inference engine 1600.

In the step (S2400) of generating a query to be input to the second model by performing second processing on the first data set with reference to the constraint information, the data processing logic 1610 of the inference engine 1600 may be implemented to generate a query to be input to the second model by performing second processing on the first data set with reference to the constraint information. This is a process of converting the structured analysis result of the first model into a query in natural language form that the second model can understand.

The query generation may be performed in two main steps. The first step is to receive a target query template to be used for the analysis with reference to the second information of the constraint information. Specifically, the data processing logic 1610 may, with reference to the second information of the constraint information, obtain, from the Rules/Queries DB of the data processing logic 1610, a target query template associated with the constraint identifier (rule identifier) included in the first data set.

The second step is to generate the query by computing values for variables included in the target query template based on the first data set, with reference to the third information of the constraint information. For example, the data processing logic 1610 may, with reference to the third information of the constraint information, extract the bbox of an object (e.g., person_001) from the first data set, and substitute the {bbox} variable existing in the target query template, thereby generating the final query.

In the step (S2500) of querying the second model, which generates an output in text form, based on the generated query, the data processing logic 1610 of the inference engine 1600 may be configured to query the second model 1620, which generates an output in text form, by inputting the generated query thereto. The second model 1620 is a multi-modal model including a vision-language model (VLM), and may be configured to receive both an image and text and generate a response in natural language form. Accordingly, the query may further include an image, and the image may be the image used for the analysis included in the first data set.

Meanwhile, as previously described, the data processing logic 1610 may be implemented to deliver the query to the second model 1620 mapped with reference to the constraint identifier, in particular the rule set identifier, included in the first data set.

The second model 1620 may receive the text query and the image as inputs, combine the visual content of the image with the meaning of the text query to understand the context, and generate and output a response to the query in natural language form.

In the step (S2600) of performing third processing on the output generated through the second model with reference to the constraint information, the data processing logic 1610 of the inference engine 1600 may be implemented to perform third processing on the output generated through the second model 1620 with reference to the constraint information. The output of the second model 1620 may be in natural language text form, and a parsing process for converting it into structured data is required.

The third processing on the output of the second model 1620 is performed in two main steps. The first step is to receive a target parser to be used for the analysis with reference to the fourth information of the constraint information. Specifically, the data processing logic 1610 may, with reference to the fourth information of the constraint information, obtain a target parser associated with the constraint identifier (rule identifier) included in the first data set.

The second step is to parse the output generated through the second model 1620 using the received target parser. Parsing is a process of extracting key information from natural language text and converting it into a structured form. For example, when the output of the second model is “No, this person is not wearing a safety helmet.”, the parser may be configured to extract the keyword “No” and generate structured data such as {“helmet_worn”: False}.

In the step (S2700) of generating event information based on the result of the first processing and the result of the third processing, the data processing logic 1610 of the inference engine 1600 may be implemented to generate event information based on the result of the first processing and the result of the third processing. The event information is the final result of the analysis, and may be stored in the short-term memory of the data processing logic 1610, provided to the user through the client terminal 200, or transmitted to an external system (e.g., a Command Center).

The event information may include a video used for the analysis, an embedding or a metric related to the result of the first processing, the type of event detected by the third processing, and/or the constraint information.

The video used for the analysis is the original image or cropped image used for the first processing and/or the second processing, and allows the user to visually confirm the detected event.

The embedding or metric related to the result of the first processing is metadata and analysis data generated by the first model, and may include, for example, object bounding box coordinates, a confidence score, an object tracking ID, and metrics computed in relation to a specific domain (e.g., computed traffic volume, average vehicle speed, and/or the average distance between pedestrians and vehicles, whether each object is wearing work clothes and a safety helmet, and the like).

The type of event detected by the third processing is the classification of the event determined based on the parsed VLM output, and may have a form such as “PPE_Violation_NoHelmet,” “Traffic_Accident,” “Worker_HazardZoneEntry.”

The constraint information may include the constraint identifier (the rule set ID, the rule ID) indicating by which rule the event has been detected, and through this, tracking and management of the event are possible.

As a specific example, in the case of a safety helmet non-wearing event, event information may be generated including a video used for the analysis (an image/cropped image related to the safety helmet non-wearing object), an embedding or metric (person_bbox, detection_confidence, and the like), an event type (“PPE_VIOLATION_NO_HELMET”), and/or constraint information (ruleset_id, rule_id, applied_parameters, and the like).

In addition, the event information may be generated or stored to include a channel identifier, a unique identifier, a timestamp, an identifier for the applied query (prompt), the risk level of the event, the progress status of the event, and/or the time to live (TTL).

Meanwhile, the data processing logic 1610 may be implemented to generate the event information by matching the result of the first processing and the result of the third processing using the rule identifier or rule set identifier included in the first data set of the image processing pipeline 1500.

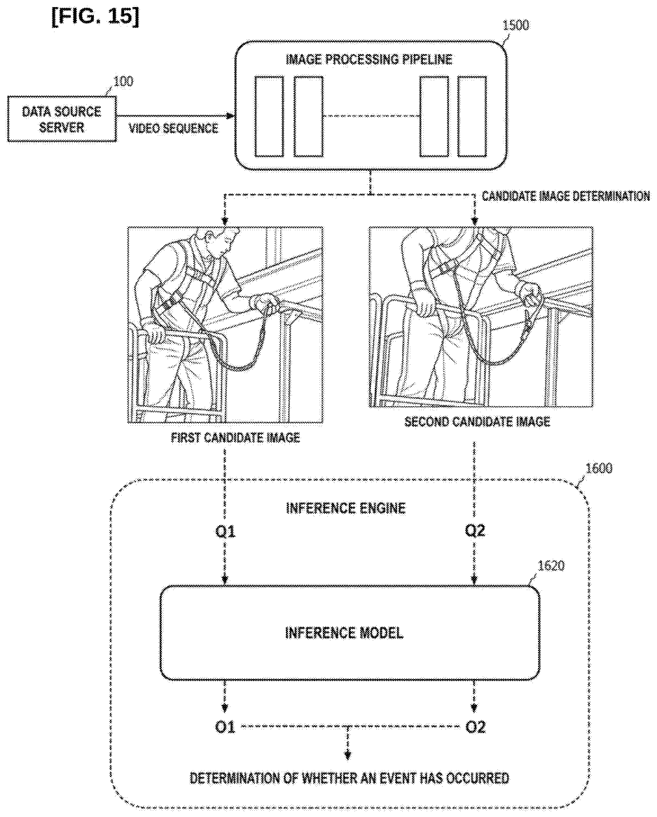

Hereinafter, with reference to FIGS. 15 to 18, various aspects of detecting exemplary events using the inference pipeline (IP) according to an embodiment of the present application will be described.

FIGS. 15 to 18 are diagrams for explaining aspects of detecting exemplary events using the constructed inference pipeline (IP) according to an embodiment of the present application.

Specifically, FIG. 15 illustrates a method for analyzing an event by capturing the start and end times of an action of interest according to an embodiment of the present invention.

As shown in FIG. 15, the event analysis method of the present invention may operate in a manner of selecting two candidate images to determine whether a specific action has occurred, and independently generating queries for each image to query the inference model 1620.

Specifically, the image processing pipeline 1500 may be configured to select, from a video sequence received from the data source server 100, a first candidate image corresponding to the start time of an action of interest and a second candidate image corresponding to the end time thereof. The example of FIG. 15 shows a case in which a hazardous action of a worker unfastening a safety hook and not refastening it is detected. The first candidate image may represent an image of a state in which the action of unfastening the hook has started (e.g., the hook unfastened), and the second candidate image may represent an image of the state at a time at which a certain time has elapsed from the time corresponding to the first candidate image (e.g., the hook fastened or still unfastened).

The selected two candidate images may be utilized to generate independent queries (Q1, Q2), respectively. A query (Q1) for querying the start of the action of interest may be generated based on the first candidate image, and a query (Q2) for querying the end of the action of interest or whether the hazardous state continues may be generated based on the second candidate image.

The generated query (Q1) and the first candidate image are input as a first input value of the second model 1620, so that the second model 1620 generates a first response (O1) based on the first input value, and the generated query (Q2) and the second candidate image are input as a second input value of the second model 1620, so that the second model 1620 may be configured to generate a second response (O2) based on the second input value. By thus inputting the two candidate images independently rather than simultaneously into the multi-modal model, the state at each time can be clearly determined.

The inference engine 1600 may be configured to determine that an event of interest has occurred when the first response (O1) and the second response (O2) correspond to a predetermined response combination. For example, in the example of FIG. 15, when the first response (O1) is about “the hook is unfastened” and the second response is also about “the hook is still unfastened,” the combination of these two responses may be determined as an event of interest meaning that “a hazardous action of unfastening the safety hook and not refastening it has occurred.” On the contrary, when the first response is about “the hook is unfastened” but the second response is about “the hook is fastened,” it may be determined that the worker has refastened the hook, and therefore no hazard event has occurred.

The selection of the second candidate image may be performed in various ways. In an embodiment, the second candidate image may be heuristically determined as an image at a time at which a predetermined time has elapsed from the time corresponding to the first candidate image. For example, based on safety regulations or empirical rules that the action of refastening a safety hook should typically be completed within a specific time (e.g., 3 seconds), an image taken a specific time (3 seconds) after the time corresponding to the first candidate image may be selected as the second candidate image. In another embodiment, the second candidate image may be determined by analyzing the amount of change with respect to the first candidate image. For example, the first model may continuously analyze frames to track the position of the worker's hand or the state change of the safety hook, and an image at a time at which the amount of change exceeds a threshold value may be selected as the second candidate image.

This two-image-based action determination method can effectively detect actions of interest accompanied by temporal changes that are difficult to determine using only a single image, and has the advantage of clearly determining whether a hazardous action has occurred by independently evaluating each time point. In particular, in situations such as the unfastening and refastening of safety equipment in which a temporary deviation from a normal state must return to the normal state, the actual hazardous situation can be accurately detected by confirming the return.

Meanwhile, FIG. 15 has been described as detecting a specific event. However, this is merely an example for the convenience of explanation, and the method may be applied to detect events of interest related to any appropriate actions accompanied by temporal changes.

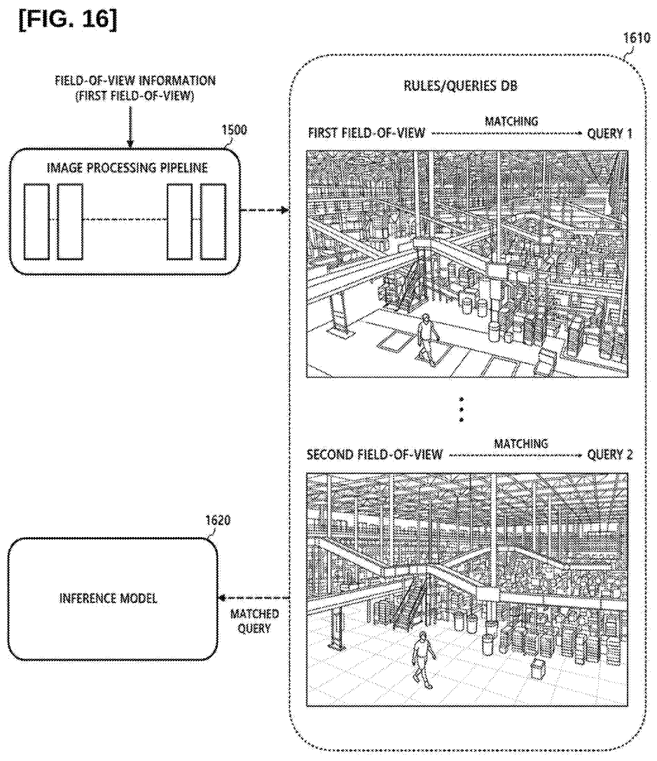

FIG. 16 illustrates a method for selecting an optimal query in consideration of camera field-of-view information according to an embodiment of the present invention.

As shown in FIG. 16, the event analysis method of the present invention may operate in a manner of selecting a query (prompt) whose performance has been verified in advance according to the field-of-view information of the camera that captured the video stream, to generate a query.

Specifically, the image processing pipeline 1500 may obtain the field-of-view information of the camera that captured the video stream in the process of performing the first processing. The field-of-view information may indicate the field of view of the camera. The example of FIG. 16 shows a situation in which an image captured at a first field of view is input to the image processing pipeline 1500.

A plurality of candidate queries previously matched according to camera fields of view for the same analysis purpose (target rule set) may be stored in the Rules/Queries DB inside the data processing logic 1610. For example, with respect to a rule set for detecting whether a worker is wearing safety equipment, a query (Query 1) optimized for the first field of view and a query (Query 2) optimized for a second field of view may be stored, respectively.

In the query generation step, the data processing logic 1610 may be implemented to determine, as the target query, a query matched with the corresponding field-of-view information from among the plurality of candidate queries based on the obtained field-of-view information. In the example of FIG. 16, when field-of-view information corresponding to the first field of view is obtained, the data processing logic 1610 may be configured to select the query (Query 1) matched with the first field of view from the Rules/Queries DB, and to deliver input data based on the query (Query 1) to the second model 1620. If field-of-view information corresponding to the second field of view is obtained, the data processing logic 1610 may be configured to select the query (Query 2) matched with the second field of view from the Rules/Queries DB, and to deliver input data based on the query (Query 2) to the second model 1620.

This method of selecting a query based on the field of view may provide an advantage of consistently maintaining high analysis performance in response to the diversity of camera installation environments. By preparing queries whose performance has been verified in advance for each field of view, optimized analysis can be performed regardless of the on-site camera installation conditions. In addition, when applying the same rule set to various sites, an effect of improving convenience may be provided in that, as long as the field-of-view information is automatically detected, an appropriate query is selected, so that the user does not need to separately modify or adjust the query.

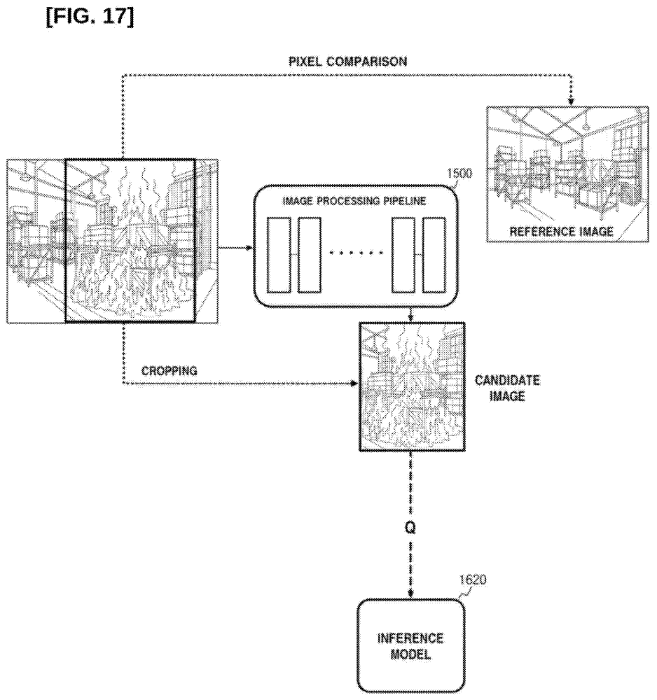

FIG. 17 illustrates a method for detecting an abnormal situation by comparing a reference image of a normal situation with a current image according to an embodiment of the present invention.

As shown in FIG. 17, the event analysis method of the present invention may operate in a manner of comparing a current image with a reference image for a normal situation as a baseline, and selectively generating a query for a corresponding region when a difference occurs.

Specifically, the image processing pipeline 1500 may obtain a reference image for a normal situation in the process of performing the first processing. The reference image is a baseline image representing a normal state of the space being monitored, and may be captured at the time of initial system setup or generated by learning the normal state for a certain period. For example, in the case of monitoring the inside of an industrial site, an image of an everyday state without smoke or fire may be used as the reference image.

The first model of the image processing pipeline 1500 may be configured to compare the reference image with a current image of the video stream. This comparison may be performed through various computer vision techniques such as pixel-by-pixel difference analysis, feature point matching, or image similarity measurement.

According to the result of the comparison, when the difference between the reference image and the current image is greater than a threshold value, it may be determined that the current image is a candidate image for an abnormal situation that is not the normal situation. For example, in a smoke detection scenario, when an opaque region of gray or white that is not present in the reference image appears in the current image, the current image may be determined as a candidate image for an abnormal situation.

Furthermore, in the query generation step, a region of interest in which a difference exists may be determined by comparing pixels included in the reference image with pixels included in the candidate image for the abnormal situation. The data processing logic 1610 may be implemented to receive a cropped image including the region of interest, and to generate the query based on the received cropped image.

For example, in a smoke detection situation, if a meaningful difference in pixel values is detected in a specific region near the ceiling as a result of comparing the reference image with the current image, a cropped image of the corresponding region may be generated. The data processing logic 1610 may be configured to generate the cropped image and a query based on a target rule related to smoke detection (e.g., “In the highlighted region of the image, is there any smoke or abnormal substance? Answer Yes or No and describe what you see.”) and to deliver them to the second model (VLM). In this case, the second model 1620 may focus on the cropped region of interest, determine the presence of smoke, and output a response regarding the occurrence of an event.

This reference image-based abnormal situation detection method may provide the advantages of increasing computational efficiency by selectively performing inference only in regions where a change has occurred, and improving analysis accuracy by allowing the inference model to focus on the changed portion through cropping the region of interest.

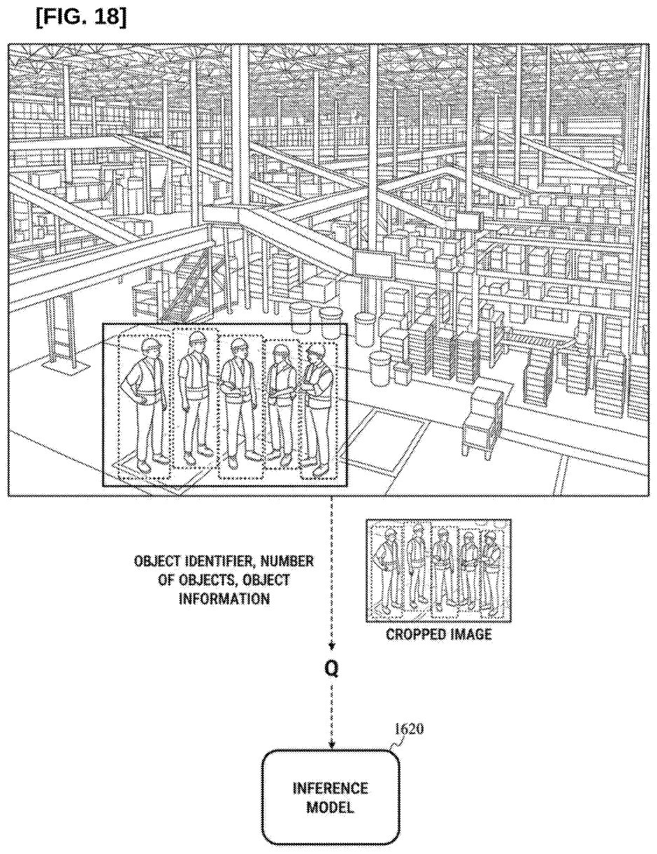

FIG. 18 illustrates a method for identifying a situation in which a plurality of objects are present and analyzing an event based thereon according to an embodiment of the present invention.

As shown in FIG. 18, the event analysis method of the present invention may operate in a manner of identifying a situation in which at least two or more objects (preferably three or more objects) are present in the video stream, generating a cropped image including the corresponding objects, and selectively configuring a query.

Specifically, the image processing pipeline 1500 may be configured to identify a situation in which at least two or more objects are present based on the video stream in the process of performing the first processing. The example of FIG. 18 shows a situation in which a plurality of workers are gathered in a specific area inside an industrial site. The first model may individually detect each worker and extract the bounding box of each individual object and the coordinate information of the bounding box.

When a plurality of objects are identified, in the first processing step, the image processing pipeline 1500 may be configured to generate a cropped image that includes all of these objects. For example, the area indicated by a dotted line in FIG. 18 represents a cropped area that includes all of the plurality of workers. This cropped image may be set as a minimum bounding region encompassing the bounding boxes of the individual objects, or may be generated to include appropriate margins.

In the query generation step, the data processing logic 1610 may be implemented to generate a query based on at least one of an identifier for each of the objects, object information, the number of objects, and the cropped image. For example, from the first data set, information that five workers have been detected (the number of objects), object identifiers, location information of each worker (object information), and/or the cropped image may be extracted, and the data processing logic 1610 may be implemented to generate, based thereon, a query according to a target rule regarding multi-object detection (e.g., “In the image, 5 people are detected at the following locations: (x1, y1, x1′, y1′, id1), (x2, y2, x2′, y2′, id2), (x3, y3, x3′, y3′, id3), (x4, y4, x4′, y4′, id4), (x5, y5, x5′, y5′, id5). Are these people gathered in a group? If yes, describe their interaction”).

The generated query and the cropped image may be input to the second model 1620, and the second model 1620 may be implemented to detect various events such as work interruption and/or abnormal group behavior based on the query and the cropped image.

This multi-object-based event analysis method may effectively detect group behaviors or interactions that are difficult to determine using only a single object, and may provide the advantage of detecting unstructured events that cannot be detected by computer vision models, through context understanding by the vision-language model.

Furthermore, the event analysis method of the present invention may include various embodiments of selectively generating queries in response to various situations.

In an embodiment, the image processing pipeline 1500 may be configured to identify, through the first processing, a situation in which at least one object is located in a region of interest based on the video stream, and to generate a cropped image including the corresponding region of interest and the object. In the query generation step, the data processing logic 1610 may be configured to generate the query based on the cropped image. For example, when a situation in which a worker has entered a region of interest designated as a hazard zone is identified, a cropped image including the corresponding region and the worker may be generated, and the data processing logic 1610 may be configured to generate a query for querying the occurrence of an event of interest based on the cropped image.

In an embodiment, the image processing pipeline 1500 may be configured to obtain, through the first processing, direction information (heading) of at least one object based on the video stream. In the query generation step, the data processing logic 1610 may be configured to generate different queries depending on the obtained direction information of the object. Specifically, when the direction information of the object includes first direction information, a third query (e.g., based on a query template whose performance has been verified in advance with respect to the first direction information) corresponding to the first direction information may be generated, and when the direction information includes second direction information, a fourth query (e.g., based on a query template whose performance has been verified in advance with respect to the second direction information) corresponding to the second direction information may be generated, and the second model may be queried therewith. For example, when a worker moves toward the hazard zone and when the worker moves in the opposite direction from the hazard zone, the analysis on the event of interest may be performed using different queries.

In an embodiment, the image processing pipeline 1500 may be configured to identify, through the first processing, a situation in which at least one object that has been moving has come to a stop based on the video stream, and to generate a cropped image including the corresponding object. In the query generation step, the data processing logic 1610 may be configured to generate a query corresponding to the situation of having come to a stop, based on the cropped image. For example, when a situation is identified in which a vehicle has stopped while moving on a highway, the data processing logic 1610 may be configured to deliver, to the second model, a cropped image including the object related to the identified situation and a query for determining whether an event has occurred (e.g., “Is this vehicle stopped due to an accident or mechanical failure? Are there any visible hazards?”), so as to query the second model to determine whether an event of interest has occurred.

In an embodiment, the image processing pipeline 1500 may be configured to compute, through the first processing, a confidence for a part of interest of an object present in the video stream using a pose estimation technique. Furthermore, when the confidence is greater than a predetermined threshold, the image processing pipeline 1500 may be configured to generate a cropped image of the part of interest of the object. In the query generation step, when the computed confidence is greater than the predetermined threshold, the data processing logic 1610 may be implemented to receive the cropped image of the part of interest, and to generate a query related to the wearing of protective gear on the corresponding part. For example, when the keypoint confidence for the head of a worker is detected to be higher than a predetermined confidence threshold, the data processing logic 1610 may generate, together with an image cropped from the head, a query related to whether a safety helmet is being worn (e.g., “Is this person wearing a safety helmet on their head?”), so that the second model can accurately determine whether the safety helmet is being worn. On the other hand, when the computed confidence is less than the predetermined threshold (i.e., when the part of interest is not clearly visible), the query generation may be omitted to prevent inaccurate determinations.

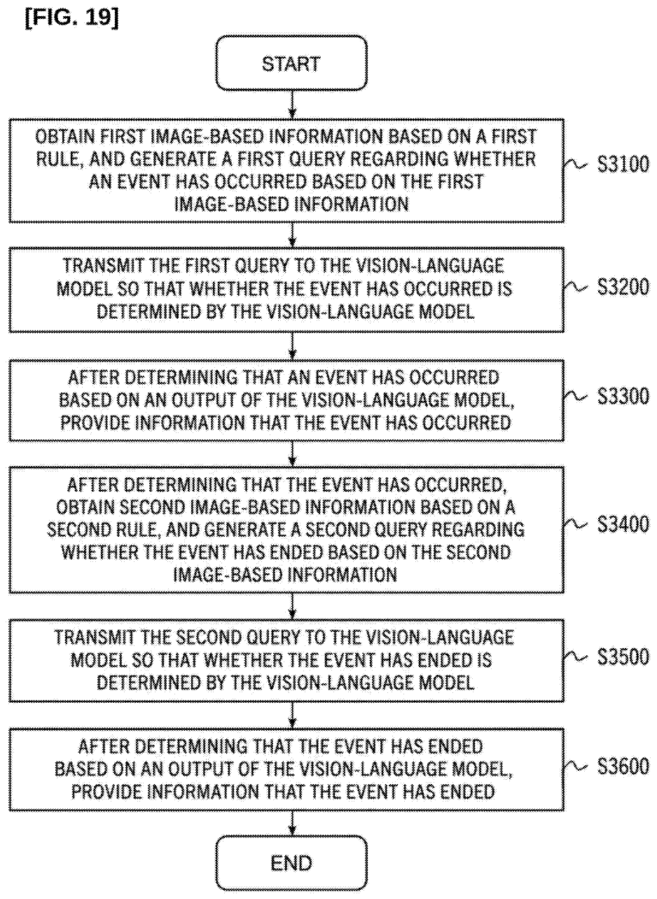

Hereinafter, with reference to FIGS. 19 to 25, a method for providing information about an event according to an embodiment of the present application will be described in more detail. Specifically, with reference to FIGS. 19 to 25, an aspect of analyzing event progress stages (event occurrence, event being addressed, event end) and providing information about the event progress stages according to an embodiment of the present application will be described in detail. Meanwhile, in describing the method for providing information about an event, some embodiments overlapping with the contents previously described with reference to FIGS. 1 to 18 may be omitted. However, this is merely for the convenience of explanation, and should not be construed as limiting, and the method for constructing the inference pipeline and the method for analyzing an event using the inference pipeline described with reference to FIGS. 1 to 18 may equally be applied to the present embodiment.

FIG. 19 is a flowchart illustrating a method for providing information about an event according to an embodiment of the present application. Specifically, as shown in FIG. 19, the event information providing method of the present invention operates in a manner that adaptively switches rules and queries according to the progress stage of the event, thereby systematically tracking the occurrence of an event, the addressing of an event, and the end of an event, and providing information to the user.

The method for providing information about an event according to an embodiment of the present application may include: a step (S3100) of obtaining first image-based information based on a first rule, and generating a first query regarding whether an event has occurred based on the first image-based information; a step (S3200) of transmitting the first query to the vision-language model so that whether an event has occurred is determined by the vision-language model; a step (S3300) of, after determining that an event has occurred based on an output of the vision-language model, providing information that the event has occurred; a step (S3400) of, after determining that the event has occurred, obtaining second image-based information based on a second rule, and generating a second query regarding whether the event has ended based on the second image-based information; a step (S3500) of transmitting the second query to the vision-language model so that whether the event has ended is determined by the vision-language model; and/or a step (S3600) of, after determining that the event has ended based on an output of the vision-language model, providing information that the event has ended.

The core feature of the present embodiment is that the first rule and the first query for determining whether an event has occurred, and the second rule and the second query for determining whether the event has ended (or the third rule and the third query for determining whether the event is being addressed) are different from each other. This is because the situations and conditions to be determined at the start time and at the end time of an event are different, and is intended to perform an analysis optimized for each stage.

In the step S3100, the data processing logic 1610 of the inference pipeline (IP) may be configured to obtain the first image-based information based on the first rule, and to generate the first query regarding whether an event has occurred based on the first image-based information. The first rule defines rules and parameters for detecting whether a specific event has occurred in a normal state. Specifically, the step (S3100) of generating the first query may further include obtaining the first image-based information from a first media processing pipeline (which may also be referred to as a first image processing pipeline) corresponding to the first rule. For example, in a traffic accident detection scenario, the first rule may define a region of interest, a confidence threshold, and the like, for confirming a vehicle collision or an abnormal vehicle stop situation in the image, and in the first media processing pipeline, an object detection model (e.g., YOLO) may be executed, and vehicle objects and analysis data (e.g., vehicle speed) may be computed. The first query may be generated in a form by which the vision-language model 1620 can determine whether an event has occurred, such as “Is there a vehicle collision or accident visible in the image?”.

In the step S3200, the data processing logic 1610 may transmit the first query (including the image) generated through the step S3100 to the vision-language model so that the vision-language model determines whether an event has occurred. The vision-language model may be configured to output a response regarding whether an event has occurred based on the first query. The data processing logic 1610 may be configured to ultimately determine whether an event has occurred based on the response of the vision-language model.

In the step S3300, the data processing logic 1610 may be implemented to provide, after determining that an event has occurred based on the output of the vision-language model, information that the event has occurred. The corresponding information (information for each event progress stage to be described below) may be displayed on a user interface (UI) through the client terminal 200, or transmitted to an external server (e.g., a Command Center) to enable an immediate response.

In an embodiment, the first query may include a plurality of sub-queries, rather than a single query. In this case, the data processing logic 1610 may be implemented to determine that an event has occurred when the occurrence of an event has been detected with respect to at least one sub-query among the plurality of sub-queries. For example, in the case of traffic accident detection, the first query may include sub-queries such as (1) “Are there any vehicles in an abnormal position or orientation?”, (2) “Is there visible vehicle damage or collision?”, and (3) “Are there any stopped vehicles blocking traffic lanes?”. In this case, when even one of these sub-queries outputs, through the vision-language model, a response indicating that a traffic accident has been detected, the data processing logic 1610 may be implemented to determine that a traffic accident event has occurred.

After it has been determined that an event has occurred, the inference pipeline (IP) may be automatically switched to a mode for performing detection of the event end. Such switching may be automatically performed by relevant sub-rules included in the target rule generated during the construction of the inference pipeline (IP) described above. By such switching, the first rule for detecting the occurrence of the event may be changed to the second rule for detecting the end of the event (or the third rule for detecting whether an action responsive to the event is being performed, which will be described below).

In the step S3400, the data processing logic 1610 of the inference pipeline (IP) may be configured to obtain the second image-based information based on the second rule, and to generate the second query regarding whether the event has ended based on the second image-based information. The second rule defines rules and parameters for determining whether the event that has occurred has ended. Specifically, the step (S3400) of generating the second query may further include obtaining the second image-based information from a second media processing pipeline (which may also be referred to as a second image processing pipeline) corresponding to the second rule. Meanwhile, at least one model that is different from a model executed in the first media processing pipeline may be executed in the second media processing pipeline. Here, the meaning that the models are different may encompass that setting values for at least one parameter included in the models are different. As an example, the second query may be generated in a form by which the vision-language model can determine whether the event has ended, such as “Have the accident vehicles been cleared from the road? Is traffic flowing normally?”.

In the step S3500, the data processing logic 1610 may transmit the second query (including the image) generated through the step S3400 to the vision-language model so that the vision-language model determines whether the event has ended. The vision-language model may be configured to output a response regarding whether the event has ended based on the second query. The data processing logic 1610 may be configured to ultimately determine whether the event has ended based on the response of the vision-language model.

In the step S3600, the data processing logic 1610 of the inference pipeline (IP) may be implemented to provide, after determining that the event has ended based on the output of the vision-language model, information that the event has ended.

In an embodiment, the information that the event has ended may not be provided immediately, but may be provided after a certain period of time. Specifically, the data processing logic 1610 may be implemented to obtain an event end time at which the event is determined to have ended based on the output of the vision-language model, and to output the information that the event has ended at a time at which a predetermined time has elapsed from the event end time. This is to prevent a situation in which the event appears to have temporarily ended but recurs. Meanwhile, when it is determined that an event has occurred again during the predetermined period, the data processing logic 1610 may be implemented to maintain the providing of the information that the event has occurred without outputting the information that the event has ended.

In another embodiment, whether the event has ended may be confirmed not by a single determination but through multiple verifications. Specifically, the data processing logic 1610 may be implemented to determine that the event has ended after the end of the event has been detected for a predetermined number of times (e.g., n=3) based on the second query and the output of the vision-language model. Through this, temporary misjudgments can be prevented, and the reliability of the event end determination can be increased.

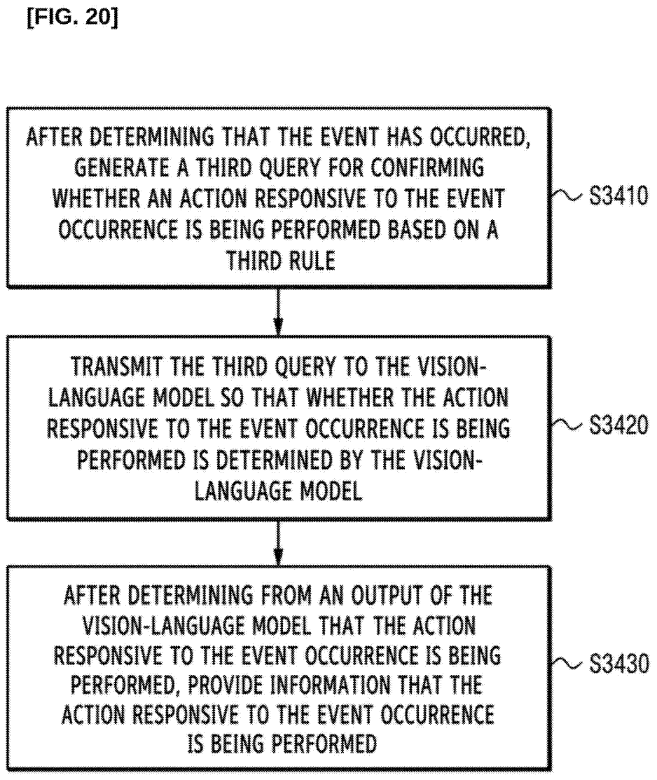

FIG. 20 is a specific flowchart of the method for providing information about an event according to an embodiment of the present application. Specifically, FIG. 20 is a flowchart illustrating an aspect of analysis for each event progress stage including a step of determining whether an action responsive to event occurrence is being performed after an event has occurred, according to an embodiment of the present invention.

The step (S3400) of generating, after determining that the event has occurred, the second query regarding whether the event has ended according to an embodiment of the present application may further include: a step (S3410) of, after determining that the event has occurred, generating a third query for confirming whether an action responsive to event occurrence is being performed based on a third rule; a step (S3420) of transmitting the third query to the vision-language model so that whether the action responsive to event occurrence is being performed is determined by the vision-language model; and/or a step (S3430) of, after determining that the action responsive to event occurrence is being performed based on the output of the vision-language model, providing information that the action responsive to event occurrence is being performed.

In the step S3410, the data processing logic 1610 of the inference pipeline (IP) may be implemented to generate, after determining that the event has occurred, a third query for confirming whether an action responsive to event occurrence is being performed based on a third rule. The third rule defines rules and parameters for determining whether an appropriate response action is being taken in response to the event that has occurred. For example, in a traffic accident detection scenario, the third rule may define conditions for confirming the arrival of an ambulance, a police car, or a tow truck, response personnel activities at the accident scene, and the like, and based on the third rule, the media processing pipeline may be configured to detect objects related to ambulances, police cars, or tow trucks in the image. The third query may be generated in a form by which the vision-language model can determine whether an action responsive to the event is being performed, such as “Are there any emergency responders or vehicles present at the accident scene? Is assistance being provided?”.

In the step S3420, the data processing logic 1610 may transmit the third query generated in the step S3410 to the vision-language model so that the vision-language model determines whether the action responsive to event occurrence is being performed, thereby allowing the vision-language model to determine whether the action responsive to the event is being performed. The vision-language model may be configured to output a response regarding whether the action responsive to the event is being performed, based on the third query. The data processing logic 1610 may be configured to ultimately determine whether the action responsive to the event is being performed based on the response of the vision-language model.

According to an embodiment, the first query for confirming the occurrence of the event described above may be transmitted to the vision-language model at a predetermined first time period. On the other hand, the second query for confirming the end of the event and/or the third query for confirming whether the action responsive to the event is being performed may be transmitted to the vision-language model at a second time period that is different from the first time period. In this case, the first time period may be characterized in being shorter than the second time period. This is because the confirmation of the occurrence of an event has a relatively higher urgency compared to the confirmation of the action or the confirmation of the end. By setting the first time period to be short, whether a new event has occurred can be quickly detected, and through this, an effect of shortening the initial response time and enabling rapid action may be provided.

In the step S3430, the data processing logic 1610 may be implemented to provide, after determining from the output of the vision-language model that the action responsive to the event is being performed, information that the action responsive to event occurrence is being performed. Through this, an effect may be provided in which the user can clearly grasp the progress stage of the event.

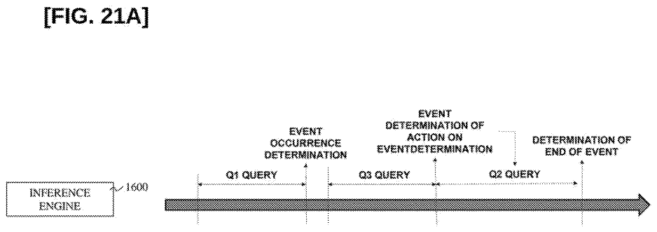

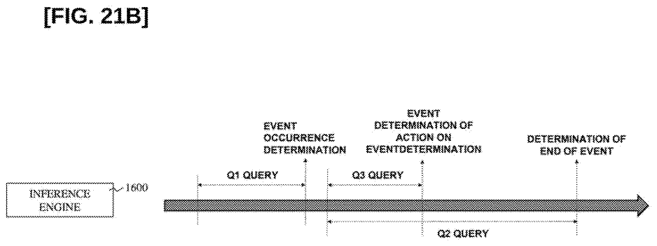

FIG. 21 is a diagram for explaining an aspect of event analysis according to a progress stage of an event according to an embodiment of the present application. Specifically, FIG. 21(a) is a diagram for explaining an aspect in which the process of determining whether an action responsive to an event is being performed and the process of determining whether the event has ended are sequentially executed, and FIG. 21(b) is a diagram for explaining an aspect in which the process of determining whether an action responsive to an event is being performed and the process of determining whether the event has ended are executed in parallel.

As shown in FIG. 21(a), in an embodiment, the second query (Q2) for confirming whether the event has ended may be generated after obtaining, in response to the third query (Q3) for confirming whether an action responsive to event occurrence is being performed, the information that the action responsive to event occurrence is being performed. This is a sequential approach in which whether an action responsive to the event is being performed is confirmed first, and then whether the event has ended is determined.

Specifically, the inference engine 1600 may be implemented to confirm the occurrence of the event through the querying of the first query (Q1), and subsequently to determine whether the action responsive to the event is being performed through the querying of the third query (Q3). Furthermore, the inference engine 1600 may be implemented to generate the second query (Q2) after it has been determined that the action responsive to the event is being performed, and to confirm whether the event has ended through the vision-language model. For example, in the case of a high-severity traffic accident, since the removal of the accident vehicles and the normalization of traffic (i.e., the end of the event) is possible only after an ambulance and the police arrive and perform an action, it may be reasonable to confirm the action first.

As shown in FIG. 21(b), in another embodiment, the second query (Q2) for confirming whether the event has ended and the third query (Q3) for confirming whether an action responsive to the event is being performed may be generated in parallel and transmitted to the vision-language model. Specifically, the inference engine 1600 may be implemented to generate and transmit the second query (Q2) to the vision-language model at least once for a first time interval included between a time at which the event is determined to have occurred and a time at which the event is determined to have ended. On the other hand, the inference engine 1600 may be implemented to generate and transmit the third query (Q3) to the vision-language model at least once for a second time interval included between the time at which the event is determined to have occurred and the time at which the event is determined to have ended. In this case, the first time interval and the second time interval may at least partially overlap with each other. That is, the process of confirming whether the event has ended and the process of confirming whether an action responsive to the event is being performed may be performed in parallel. For example, in the case of a minor traffic accident, since the accident vehicles can be quickly removed and the event ended even without official emergency action, it may be reasonable to perform the event end confirmation through the second query (Q2) and the action confirmation through the third query (Q3) in parallel, thereby simultaneously monitoring which condition is fulfilled first.

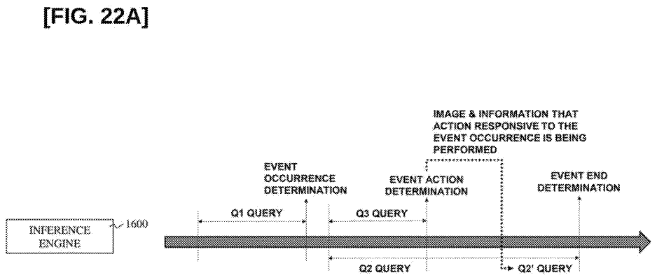

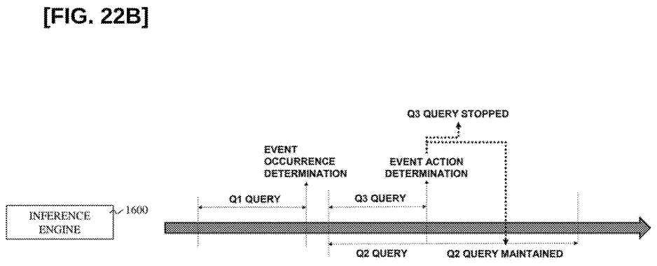

FIG. 22 is a diagram for explaining an aspect of event analysis according to a progress stage of an event according to an embodiment of the present application. Specifically, FIG. 22 illustrates a detailed aspect when, in the parallel execution scheme according to FIG. 21(b), it is determined that the action responsive to the event is being performed before it is determined that the event has ended.

According to an embodiment, in a situation where the confirmation of the end of the event and the confirmation of whether an action responsive to the event is being performed are performed in parallel, when it is first determined through the third query (Q3) that the action responsive to event occurrence is being performed, the inference engine 1600 may adaptively switch the analysis mode.

Referring to FIG. 22(a), the figure shows the query switching after it has been determined first that the action responsive to the event is being performed. Specifically, after the occurrence of the event has been confirmed through the first query (Q1), the second query (Q2) for confirming whether the event has ended and the third query (Q3) for confirming whether an action responsive to the event is being performed may be queried in parallel. In this process, when, based on the response to the third query (Q3), it is first determined that the action responsive to the event is being performed, the inference engine 1600 may be implemented to regenerate a second query (Q2′) based on the information that the action responsive to event occurrence is being performed and a new image.

Specifically, the inference engine 1600 may, in response to determining that the action responsive to event occurrence is being performed, obtain second image-based information based on the second rule, and generate the second query using the second image-based information as one input and the information that the action responsive to event occurrence is being performed as another input. For example, in a traffic accident scenario, when action information indicating that an ambulance and the police have arrived at the scene is confirmed, the inference engine 1600 may be implemented to generate, based on the action information, a query (Q2′) for confirming whether the event has ended that reflects the action situation, such as “Given that emergency responders are now present, have the accident vehicles been cleared and is traffic resuming?”.

Meanwhile, the information that the action responsive to event occurrence is being performed may be information generated from third image-based information distinguished from the second image-based information. In this case, the third image-based information may be obtained based on a third rule for confirming whether the action responsive to the event is being performed (or a third rule optimized for confirming whether the action responsive to the event is being performed). Further, the third query for confirming whether the action responsive to the event is being performed may be generated based on the third image-based information. Since this is similar in aspect to the aforementioned first and second image-based information, the first and second rules, and/or the first and second queries, a detailed description thereof will be omitted.

According to an embodiment, the inference engine 1600 may be implemented, in response to determining that the action responsive to event occurrence is being performed, to cease the querying of the vision-language model with the third query (Q3) while maintaining the querying of the vision-language model with the second query (Q2). This is because, since it has been confirmed that the action responsive to the event is being performed, there is no longer a need to repeatedly confirm whether the action is being performed, and now the focus is to be concentrated on confirming the end of the event. Referring to FIG. 22(b), while the querying through the second query (Q2) continues to be performed, when whether the action responsive to the event is being performed is confirmed through the querying of the third query (Q3), the querying through the third query (Q3) is ceased, whereas the querying through the second query (Q2 or Q2′) is maintained, so that the end of the event is ultimately confirmed.

This adaptive query switching method enables more accurate and context-appropriate event tracking by dynamically adjusting the analysis strategy according to the actual progress of the event.

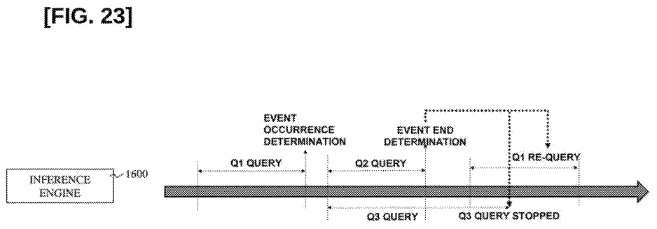

FIG. 23 is a diagram for explaining an aspect of event analysis according to a progress stage of an event according to an embodiment of the present application. Specifically, FIG. 23 illustrates a detailed aspect when, in the parallel execution scheme according to FIG. 21(b), it is determined that the event has ended before the action responsive to the event is confirmed.

According to an embodiment, in a situation where the confirmation of the end of the event and the confirmation of whether an action responsive to the event is being performed are performed in parallel, when the end of the event is first confirmed through the second query (Q2), the inference engine 1600 may adaptively switch the analysis mode.

Specifically, the inference engine 1600 may be implemented, in response to determining that the event has ended, to cease the querying of the vision-language model with the third query (Q3) and/or the second query (Q2). This is because, since the event has ended, there is no longer a need to continue confirming whether an action responsive to the event is being performed or whether the event has ended. In this case, the inference engine 1600 may be implemented to regenerate the first query (Q1) regarding whether an event has occurred and to query the vision-language model with the regenerated first query (Q1). This means that the event analysis system returns to the normal-state monitoring mode and prepares to detect the occurrence of a new event. FIG. 23 shows that the requerying of the first query (Q1) starts after the “event end determination,” through which the system can monitor events cyclically. Such a processing scheme can effectively cope with situations in which an event may end naturally even without action confirmation. For example, in a minor traffic accident, when the parties promptly move their vehicles and traffic returns to normal, the traffic accident event may end without action being taken on the event. In such a case, rather than continuing to perform the action confirmation, it may be more efficient to immediately recognize the end and switch the analysis mode to detect a new event that may occur next.

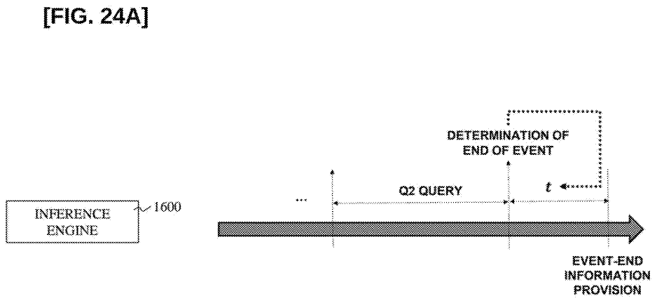

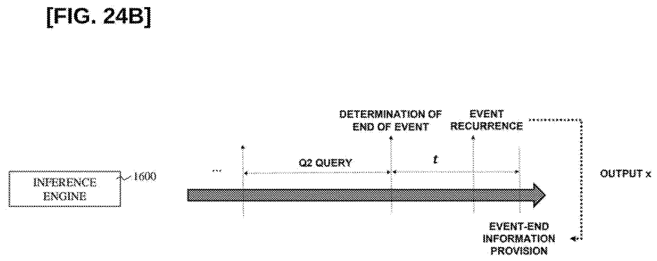

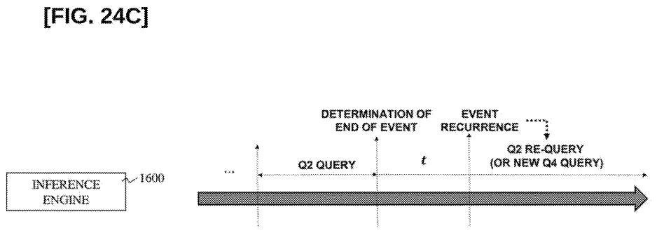

FIG. 24 is a diagram for explaining an aspect of event analysis according to a progress stage of an event according to an embodiment of the present application. Specifically, FIG. 24 is a diagram for explaining an aspect of analysis when event end information is provided after a certain period of time has elapsed after the event end has been determined, and when the event recurs before the certain period of time has elapsed.

As previously described in FIG. 19, according to an embodiment, the information that the event has ended may be implemented to be provided not immediately but after a certain period of time. FIG. 24 shows specific scenarios of such a scheme.

FIG. 24(a) illustrates a situation in which the end of the event is finalized. As described above, the inference engine 1600 may be implemented to display, to the user, the information about the end of the event after a predetermined time (t) has elapsed from the time at which the event is determined to have ended through the querying of the second query (Q2).

According to an embodiment, during the delay period (t), the inference pipeline (IP) detects whether the event recurs, and may be implemented to provide the information about the end of the event when it is confirmed that there is no recurrence.

FIG. 24(b) illustrates a case in which the event recurs during the delay period (t). While waiting for the predetermined time (t) to elapse after the end of the event has been determined through the second query (Q2), the recurrence of the event may be detected. The recurrence of the event may be detected by being configured such that the first query (Q1) is queried during the delay period (t). In this case, the inference pipeline (IP) may be implemented not to output the information that the event has ended, and to maintain the providing of the information that the event has occurred.

FIG. 24(c) illustrates a case in which additional verification is performed when the event recurs. When it is determined that an event has occurred again between the event end time and the time at which the predetermined time has elapsed, the event analysis system may respond in one of the following two ways.

First, the inference engine 1600 may be implemented to deliver the second query (Q2) again to the vision-language model during the predetermined time (t) to reconfirm whether the event has ended. Second, the inference engine 1600 may be implemented to generate a new fourth query regarding whether the event has started again, and to query the vision-language model therewith.

This mechanism for the delayed provision of the event end information and for handling recurrence may provide an effect of preventing misjudgments due to temporary changes in the situation, and increasing the reliability of the system by providing the event end information only after it is confirmed that the event has actually completely ended.

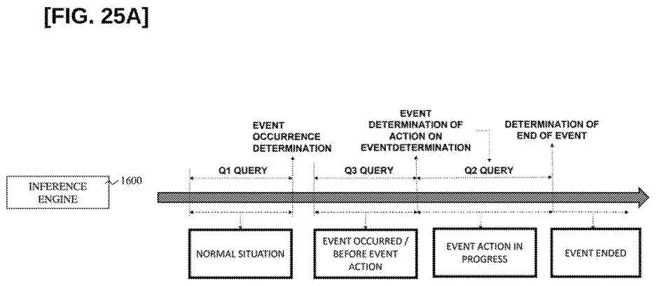

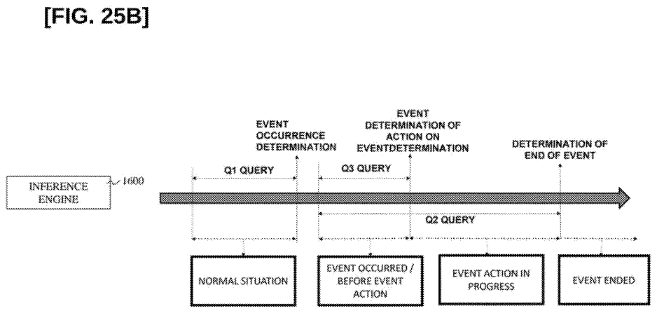

FIG. 25 is a diagram for explaining an aspect of event information provided according to a progress stage of an event according to an embodiment of the present application. Specifically, FIG. 25 is a diagram for explaining an aspect of providing different status information to a user for each progress stage of the event according to an embodiment of the present invention.

As shown in FIG. 25, the event information providing method of the present invention provides status information classified according to the progress stage of the event, thereby enabling the user to clearly grasp the current situation.

FIG. 25(a) shows the provision of stage-by-stage information in the sequential execution scheme.

Specifically, the inference engine 1600 may be implemented to provide information indicating a “normal situation” during the first progress status interval that includes at least a part between a time at which the first query (Q1) is generated and a time at which the event is determined to have occurred. This means a state in which the event analysis system is monitoring whether an event has occurred but no anomaly has yet been detected.

Furthermore, the inference engine 1600 may be implemented to provide information indicating that “the event has occurred but the action responsive to the event has not yet been performed” during the second progress status interval that includes at least a part between a time at which the third query (Q3) is generated (or a time at which the event is determined to have occurred) and a time at which the action responsive to event occurrence is determined to be being performed. This means a state in which the event has been detected but a response action has not yet been started.

Furthermore, the inference engine 1600 may be implemented to provide information indicating that “the action with respect to the event is being performed” during the third progress status interval that includes at least a part between a time at which the second query (Q2) is generated (or a time at which the action responsive to the event is determined to be being performed) and a time at which the event is determined to have ended. This means that the response action with respect to the event is in progress, and the situation is in the process of being resolved.

Furthermore, the inference engine 1600 may be implemented to provide information indicating an “event end situation” during a fourth progress status interval that includes at least a part after the time at which the event is determined to have ended. This means that the event has been completely resolved and the system has returned to a normal state.

FIG. 25(b) shows the provision of stage-by-stage information in the parallel execution scheme. Similarly to the sequential scheme of FIG. 25(a), four stages of progress status information are provided, but the difference is that the querying for confirming whether the event has ended through the second query (Q2) and the querying for confirming whether the action responsive to the event is being performed through the third query (Q3) are temporally overlapped. In the case of the parallel execution scheme as well, appropriate status information may be provided at each progress stage, such that “normal situation,” “the event has occurred but the action responsive to the event has not yet been performed,” “the action with respect to the event is being performed,” and “event end situation” are displayed according to the actual progress of the situation.

The method for providing information about an event according to an embodiment of the present application may include further embodiments of systematically managing event information and adaptively generating queries according to the progress status.

According to an embodiment, the data processing logic 1610 of the analysis server 1000 may be implemented to store, after determining that the event has occurred, event information in the short-term memory included in the data processing logic 1610. As described above with reference to FIG. 10, the event information may be managed on a per-channel basis, and may include information regarding at least one of an identifier for a channel that captured an image used to analyze the event, a unique identifier (UUID), an event type, an identifier for a query input to the vision-language model, a time to live (TTL) for the event information, a risk level of the event, and a progress status of the event. Here, the progress status of the event may be classified into states such as the “event occurrence,” “before the action responsive to the event is performed,” “the action with respect to the event is being performed,” “the end of the event,” and the like described above.

According to an embodiment, the data processing logic 1610 may be implemented to dynamically change the rule to be applied to the analysis with reference to the progress status of the event in the event information stored in the short-term memory. Specifically, the data processing logic 1610 may, with reference to the progress status of the event in the event information (e.g., the event has occurred), determine to change the first rule for confirming whether the event has occurred to the second rule for confirming whether the event has ended (or the third rule for confirming whether the action responsive to the event is being performed). In addition, the data processing logic 1610 may be implemented to generate the second query (or the third query) whose performance has been verified in advance with respect to the changed second rule (or third rule). That is, the prompt to be applied varies depending on the progress status of the event, and the prompt to be applied according to the progress stage of the situation being detected may be adjusted to a prompt that has been verified in advance or a prompt directly input by the user. For example, when the progress status of a traffic accident event is changed to “event occurrence,” the data processing logic 1610 may detect this and may be implemented to switch the existing first rule (a rule for detecting the occurrence of an accident) to the second rule (a rule for detecting the end of the accident), and to generate the second query whose performance has been verified with respect to the second rule.

In an embodiment, the second query and/or the third query may be generated to have a chain prompt form together with the first query. This means that the event is detected and updated in its progress stages in the form of a chain prompt. The chain prompt scheme allows the result of the query at the previous stage to be utilized in the generation of the query at the next stage, thereby tracking each progress stage while maintaining the context and continuity of the event.

In an embodiment, the data processing logic 1610 may be implemented, after determining that the event has ended, to update at least one of the identifier for the query, the risk level, the time to live, and the progress status included in the event information. Through this, the entire life cycle of the event is recorded and may be utilized for subsequent analysis or statistical purposes.

In an embodiment, the event analysis system may utilize the short-term memory (STM) to preserve and utilize the context between events. Specifically, the data processing logic 1610 may be implemented to retrieve, from the short-term memory, past events that have occurred in the channel where a new or updated event has occurred, and to utilize them in the analysis of the event. The events stored in the short-term memory are managed based on the risk level and TTL (Time to Live) of the event information, and may be managed such that, when a detected event is not updated for a certain period, it is deleted from the short-term memory. In this way, past events that are determined not to affect new situations are filtered out, and the event information may be managed such that only relevant past events are utilized in the analysis of new events.

Meanwhile, when a new event is detected in a specific channel, the data processing logic 1610 may be implemented to generate a query utilizing information about past events in the short-term memory. Through this, the event analysis system according to an embodiment of the present application may provide an effect of detecting events more accurately and integratively in consideration of the context of past events, rather than simply judging individual events independently.

The features, structures, and effects described in the embodiments above are included in at least one embodiment of the present invention, and are not necessarily limited to only one embodiment. Furthermore, the features, structures, effects, and the like illustrated in each embodiment can be combined or modified for other embodiments by those of ordinary skill in the art to which the embodiments pertain. Therefore, contents related to such combinations and modifications should be construed as being included within the scope of the present invention.

In addition, although the description above has focused on the embodiments, this is merely an example and does not limit the present invention. Those of ordinary skill in the art to which the present invention pertains will appreciate that various modifications and applications not illustrated above are possible without departing from the essential characteristics of the present embodiments. That is, each component specifically shown in the embodiments may be implemented with modifications. Differences related to such modifications and applications should be construed as being included within the scope of the present invention as defined in the appended claims.

What is claimed is:

1. A method, performed by an electronic device, for constructing an inference pipeline for multi-modal analysis by industry domain, the method comprising:
obtaining an image processing pipeline package and an inference engine for multi-modal analysis, wherein the inference engine includes a domain agnostic general-purpose inference model and an industry domain-adaptive data processing logic;
obtaining, through a client terminal, a setting command for a target rule set related to a specific industry domain among a plurality of rule sets compatible with the inference engine, wherein each of the rule sets defines an inference requirement for a structured vision task for an unstructured vision task inference using the general-purpose inference model with respect to an industry domain;
obtaining, from the image processing pipeline package, at least one image processing pipeline that satisfies the inference requirement of the target rule set, based on the setting command for the target rule set; and
constructing the inference pipeline based on the at least one image processing pipeline and the inference engine.

2. The method according to claim 1, wherein:
one or more rule sets are generated for each industry domain;
the inference requirement of each rule set includes a type of structured vision inference tasks corresponding to one of a plurality of unstructured vision inference tasks predefined within one industry domain; and
the type of the structured vision inference tasks includes at least one of object detection, segmentation, classification, object tracking, and pose estimation.

3. The method according to claim 1, wherein each of the rule sets includes a rule item and a user-modifiable parameter for generating input data of the general-purpose inference model from an output of an image processing pipeline included in the image processing pipeline package for each industry domain.

4. The method according to claim 3, wherein obtaining the setting command for the target rule set further comprises:
providing, through the client terminal, the compatible rule sets;
receiving, through the client terminal, a first input for selecting the target rule set from among the compatible rule sets;
receiving, through the client terminal, a second input for selecting a specific channel to which the target rule set is to be applied; and
receiving, through the client terminal, a third input for a setting value of the user-modifiable parameter.

5. The method according to claim 4, wherein obtaining the setting command for the target rule set further comprises:
obtaining, based on the first input through the third input, a target rule, generated by applying the setting value for the user-modifiable parameter to the rule item belonging to the target rule set, for generating the input data of the inference engine, with respect to the specific channel.

6. The method according to claim 3, wherein the user-modifiable parameter includes a site-adaptive parameter, and the site-adaptive parameter includes:
a first parameter related to at least one of crop, padding, confidence threshold, region of interest, frame drop rate, frame interval, and an object type to be detected for analysis through the image processing pipeline; and
a second parameter related to a query to be input to the general-purpose inference model.

7. The method according to claim 5, wherein the target rule includes at least one of:
a rule set identifier corresponding to the target rule set;
a rule identifier corresponding to the target rule;
first information regarding a parameter for configuring an output form of the image processing pipeline or a task of the image processing pipeline;
second information regarding a query template associated with the rule identifier;
third information for generating, as the input data to be input to the general-purpose inference model, a query based on the query template and the output of the image processing pipeline; and
fourth information regarding a logic associated with the rule identifier and for processing an output of the general-purpose inference model.

8. The method according to claim 5, wherein obtaining the setting command for the target rule set further comprises:
obtaining first rule set information and first rule information previously assigned to the specific channel;
receiving a setting command for a candidate rule set and a candidate rule, based on the first input through the third input; and
restricting the candidate rule from being received as the target rule suitable for analysis with respect to the specific channel when the candidate rule set is identical to the rule set indicated by the first rule set information, and receiving the candidate rule as the target rule suitable for analysis with respect to the specific channel when the candidate rule set is different from the rule set indicated by the first rule set information.

9. The method according to claim 5, wherein obtaining the setting command for the target rule set further comprises:
obtaining second rule set information and second rule information previously assigned to a channel different from the specific channel;
receiving a setting command for a candidate rule set and a candidate rule, based on the first input through the third input; and
receiving the candidate rule, which is different from the second rule information, as the target rule suitable for analysis with respect to the specific channel, even when the candidate rule set is identical to the rule set indicated by the second rule set information.

10. The method according to claim 5, wherein constructing the inference pipeline further comprises:
constructing the inference pipeline by configuring the image processing pipeline to perform an analysis corresponding to an inference requirement corresponding to the target rule for a structured vision task for vision task inference using the general-purpose inference model, by applying the target rule with respect to the specific channel, based on the at least one image processing pipeline and the target rule.

11. The method according to claim 5, wherein constructing the inference pipeline further comprises:
generating, in response to the setting value for the user-modifiable parameter being input through the third input, structured data defining the input data of the inference engine; and
constructing the inference pipeline by configuring the image processing pipeline to generate the input data of the inference engine for the specific channel using the structured data.

12. The method according to claim 5, further comprising:
storing rule management information including at least one of an identifier of the image processing pipeline included in the inference pipeline, a parameter for executing the image processing pipeline, an identifier of a region of interest configured to be detected through the image processing pipeline, a rule set identifier corresponding to the target rule set applied for each region of interest, and a rule identifier corresponding to the target rule belonging to the target rule set, through the industry domain-adaptive data processing logic,
wherein the rule management information is stored on a per-channel basis.

13. The method according to claim 12, wherein the industry domain-adaptive data processing logic of the inference pipeline is configured to:
identify the rule set identifier included in the output of the image processing pipeline with reference to the rule set identifier of the rule management information;
map the general-purpose inference model of the inference pipeline that is to perform the unstructured vision task inference based on the identified rule set identifier; and
input the input data generated by applying the target rule into the mapped general-purpose inference model.

14. The method according to claim 13, wherein the industry domain-adaptive data processing logic of the inference pipeline is configured to:
obtain the query template associated with the rule identifier with reference to the rule identifier of the rule management information; and
generate the input data by computing a variable included in the query template using the output of the image processing pipeline.

15. The method according to claim 1, wherein constructing the inference pipeline further comprises:
allocating a resource for the image processing pipeline;
configuring an artificial intelligence model to be executed on the image processing pipeline;
configuring a channel for receiving an image to be analyzed on the inference pipeline; and
constructing the inference pipeline by generating a container of the inference pipeline based on the allocated resource, the configured artificial intelligence model, and the configured channel.

16. The method according to claim 15, wherein:
the artificial intelligence model is selected, from a model pool including a plurality of models optimized for different hardware, as at least one artificial intelligence model whose performance has been verified for hardware specification information of a server on which analysis is to be performed; and
the image processing pipeline package is selected, from a pipeline pool including a plurality of image processing pipelines optimized for different hardware, as at least one image processing pipeline whose performance has been verified for the hardware specification information of the server on which the analysis is to be performed.

17. The method according to claim 15, wherein the general-purpose inference model of the inference engine is selected, from a model pool including a plurality of inference models optimized for different hardware, as at least one general-purpose inference model whose performance has been verified in consideration of compatibility with the image processing pipeline and hardware specification information of a server on which analysis is to be performed.

18. The method according to claim 1, wherein:
obtaining the setting command for the target rule set further comprises receiving a rule setting command for at least one of a first target rule set and a second target rule set; and
when the setting command for the first target rule set is received, the inference pipeline is constructed such that a first pipeline group composed of at least one of a first image processing pipeline and a second image processing pipeline is constructed as the at least one image processing pipeline; and when the setting command for the second target rule set is received, the inference pipeline is constructed such that a second pipeline group composed of at least one of the second image processing pipeline and a third image processing pipeline is constructed as the at least one image processing pipeline.

19. A non-transitory computer-readable recording medium having a program recorded thereon for executing the method according to claim 1.

20. An electronic device comprising:
a memory; and
a processor configured to construct an inference pipeline for multi-modal analysis by industry domain, wherein the processor is configured to:
obtain an image processing pipeline package and an inference engine for multi-modal analysis, wherein the inference engine includes a domain agnostic general-purpose inference model and an industry domain-adaptive data processing logic;
obtain, through a client terminal, a setting command for a target rule set related to a specific industry domain among a plurality of rule sets compatible with the inference engine, wherein each of the rule sets defines an inference requirement for a structured vision task for an unstructured vision task inference using the general-purpose inference model with respect to an industry domain;
obtain, from the image processing pipeline package, at least one image processing pipeline that satisfies the inference requirement of the target rule set, based on the setting command for the target rule set; and
construct the inference pipeline based on the at least one image processing pipeline and the inference engine.
